(19) United States
(12) Patent Application Publication
(10) Pub. No.: US 2018/0045400 A1
(43) Pub. Date: Feb. 15, 2018

(54) Compact Lighting System for Attracting Fish and Game

(71) Applicant: Glenn Bushee, Duxbury, MA (US)

(72) Inventor: Glenn Bushee, Duxbury, MA (US)

(21) Appl. No.: 15/236,017

(22) Filed: Aug. 12, 2016

(51) Int. Cl. F21V 21/08; F21V 23/04; F21L 4/00; A01K 85/01; F21V 3/04; F21V 23/00; F21V 15/04; F21V 7/00; F21V 31/00; F21V 33/00

(52) U.S. Cl. CPC F21V 21/0832; F21V 31/005; F21V 23/0414; F21L 4/00; F21V 33/008; F21V 3/0445; F21V 23/0407; F21V 33/0008; F21V 23/005; F21V 15/04; F21V 7/00; A01K 85/01; F21Y 2115/10

(57) ABSTRACT

A compact waterproof lighting assembly includes a circuit board having a battery, a light, a switching circuit and a push button switch selectively powering the light with the battery via the switching circuit. The waterproof lighting assembly can be coupled to fishing tackle to attract fish to a fish bait. The light can be provided by a light emitting diode emitting light in any one of a number of colors or emitting ultraviolet or infrared light. The use of light emitting diodes emitting light in the ultraviolet spectrum had been found to be particularly useful for attracting fish to fish bait and birds to decoys.

### CROSS REFERENCE TO RELATED APPLICATIONS

This application is a continuation-in-part of U.S. application Ser. No. 14/142,983 entitled “Compact Lighting System with Infrared Indicator” filed Dec. 30, 2013 which is a continuation-in-part of U.S. application Ser. No. 13/957,590 entitled “Long Life Compact Lighting System” filed Aug. 2, 2013, now U.S. Pat. No. 9,206,969 which is a continuation-in-part of U.S. application Ser. No. 13/841,587 entitled “Compact Lighting System” filed Mar. 15, 2013, now U.S. Pat. No. 9,030,085 which is a continuation-in-part of U.S. application Ser. No. 13/395,612 entitled “Compact Lighting System” filed Mar. 12, 2012 which claimed priority to PCT application number PCT/US11/25668 entitled “Compact Lighting System” filed Feb. 22, 2011, now U.S. Pat. No. 9,013,100 which claimed the benefit of U.S. provisional application No. 61/339,232 entitled “Illuminated Safety Glove” filed Mar. 2, 2010. This application further claims the benefit of U.S. provisional application 62/208,400 entitled “Ultraviolet Light Strips for Decoys and Lures” filed Aug. 21, 2015, This application claims the benefit and priority of each of the applications identified above, which are incorporated herein in their entirety by reference. Pursuant to 37 C.F.R. 1.78(a)(6), this application claims the benefit of provisional application 61/339,232 filed before Mar. 13, 2013 and contains a claim to an invention having an effective date after Mar. 13, 2013.

### BACKGROUND AND SUMMARY

A need exists for a compact, lightweight portable lighting system which is low in cost and allows for single use applications. A further need exists for such a lighting system that is optionally reusable and which can be selectively and/or automatically turned on and off to conserve battery power and extend the operating life of the lighting system.

In accordance with this disclosure, a compact lighting system has been developed which can be carried on or removably applied to a substrate such as clothing, shoes, hats, helmets, gloves, shirts, pants, belts and the like to assist in alerting others of the presence of a person located in dim or dark lighting (in the dark). The compact lighting system can also be used as a location marker to provide a light signal at a chosen location such as marking a trail or marking a specific position or building or identifying the condition of a particular location with the use of the lighting system.

For example, the compact lighting system disclosed herein can be used by military and law enforcement to indicate whether or not a room, cell, building, or a natural or man-made structure has been “cleared.” One color light can indicate a “safe” condition while another color can indicate a location which has not been cleared or checked for hazards. Ultraviolet and infrared lighting can be used for tactical police and military applications. Ultraviolet lighting can be used by anglers, bird watchers and hunters for attracting fish and birds.

Because infrared (IR) light and ultraviolet (UV) light are outside the visible spectrum and not visible to the unaided eye, those compact lighting systems that emit ultraviolet or infrared light typically do not provide any visible indication whether they are powered on or powered off. While the use of IR viewing equipment such as IR goggles allows a user to tell whether the IR lights are on or off, an indicator visible to the unaided eye can also be provided on the compact lighting assembly to allow a user to tell whether the IR lights are on or off in either daylight or in the dark. For example, a visible light can be selectively activated by a user to determine whether the IR lights are on or off and also provide an indication as to the operating mode in which the IR lights are functioning.

Alternatively, a visible light can be arranged to operate automatically each time an IR or UV light is activated. In one embodiment, a visible light can be arranged in a series circuit with an IR or UV light or operate under the control of a microcircuit to visually duplicate the otherwise invisible operating mode of the IR or UV light. UV lights can be coated with or disposed adjacent to a phosphor which, when exposed to UV light, emits light in the visible spectrum. This can provide a visible indication to a user of the operating mode of a UV light.

In addition to or as an alternative to a visual indicator, a tactile or audible indicator can be provided on the compact lighting system to inform a user as to the operating state of the IR or UV lights. These states can include a constant on state, a constant off state, a slow strobed state, a fast strobed state, a high power IR or UV beam and/or a lower power IR or UV beam. A simple mechanical indicator can also be provided on a compact lighting system which operates on a simple on and off cycle.

It is important for a user to be able to tell whether the IR or UV light or lights are on or off, not only for operational purposes in the field, but also because leaving the IR and/or UV lights on when they are not required can needlessly drain battery power and can render the lighting assembly inoperable due to excessive battery drain.

Specific applications for the subject compact lighting system include an illuminated glove for directing traffic at night, illuminated helmets, safety vests, running shoes, shirts, pants, belts, or any application where the safety of an individual can be improved by a warning light. This includes use by construction workers, highway maintenance workers, joggers, cyclists, motorcyclists, airport workers, firemen, emergency responders such as ambulance workers, emergency medical technicians (EMT) and any others in proximity to traffic, construction equipment, machinery and other potential hazards. Additional applications include attracting fish and birds with specific wavelengths of light as described more fully below.

In further accordance with this disclosure, an easy-to-operate compact lighting system is provided with a removable mounting for easy convenient use on virtually any surface. The lightweight system can be hermetically sealed in a clear or translucent pouch or covered with a waterproof coating for protection against vibration, shock, harsh environments and moisture. The outer surface of the pouch overlying an on-off light switch may be textured to allow an operator to easily locate and operate the light switch solely by feel in either the light or in the dark.

Another advantageous feature of the compact lighting system is the provision of a rechargeable power source, such as a solar charged battery providing long life operation to the lighting system. The operational life of the compact lighting system can be further extended by limiting the illumination of the compact lighting system to low light or nighttime conditions such as with the use of a light-actuated on-off switch.

A radio frequency identification (RFID) device can be provided on the compact lighting system to aid in locating the system in dense cover, remote locations, under water and in any other difficult to locate environment.

Because of the compact size of the lighting assembly, it can be applied to fishing line, fishing lures and other fishing tackle to attract and catch fish as well as applied to decoys for attracting birds. The lighting assembly can be used to attract fish and birds with visible light as well as ultraviolet and infrared light. A particularly effective use combines a lighting assembly producing ultraviolet light with a live or artificial bait or decoy that reflects ultraviolet light.

Many types of birds and fish have the ability to see in the ultraviolet or “UV” wavelength spectrum of about 320 to 400 nanometers (nm), which is outside the visible light spectrum and invisible to the human eye. UV light from sunlight is included within this wavelength range known as the UVA range. However, there is also a UV B range of wavelengths from 320 to 280 nm and a UVC range of wavelengths from 280 to 200 nm. While UVA light is preferred for attracting birds and fish, UVB and UVC can in some cases also be used. Because the feathers of many birds and outer surfaces of many fish naturally reflect UV light, decoys and fish baits that reflect UV light can appear more natural to birds and fish and can perform better than those decoys and fish baits without reflected UV light.

Special paints and coatings can be applied to waterfowl and turkey decoys as well as fishing lures to approximate the natural look of the decoy or lure to that of a real bird or fish. While these UV reflective products function adequately, a user must either purchase new UV coated or UV infused decoys or lures or paint or coat older used decoys and lures that do not reflect UV light with a UV coating. This can be costly, messy and time consuming. A solution to these drawbacks is described below wherein a separate lighting assembly illuminates decoys and fish bait, including lures, with UV, infrared “IR” or visible light.

Using an ultraviolet light such as a light emitting diode “LED” that is tuned to a specific wavelength or range of wavelengths within or between about 320 and 400 nm results in a lighting assembly product well suited for use with conventional decoys and fish baits that do not reflect much or any UV light, as well as those decoys and fish baits provided with UV reflective materials, surfaces coatings and/or paints.

The UV light output from a lighting assembly as described herein can be very low yet effective for attracting birds and fish, such as below about 1000 milliwatts and typically below about 500 milliwatts. LEDs operating at about 350 milliwatts have been found effective in attracting fish. The outer surface of the lighting assembly surrounding a UV LED can be a flat black or flat white surface to minimize or eliminate light reflection from light sources other than the output of the UV LED light. The reason for reducing or eliminating external light reflection around the UV LED is that too much light reflection will cause a decoy or fish bait to look unnatural. An adhesive backing layer with a peel off cover allows the waterproof lighting assembly to be securely stuck to the surface of a decoy or lure without any structural modifications required to be made to the decoys and lures.

A flat white or flat black surface surrounding a UV LED allows the UV lighting assembly to be placed in specific spots under or below the white or lightly colored areas of a decoy or lure and/or black or dark colored areas of a decoy or lure to create a natural appearance to passing birds and fish. The objective with any decoy for hunting or bird watching is to attract similar birds flying high overhead and fool them into believing that the decoys are other real birds and attract them to a decoy set. A white surface around a LED placed adjacent a white or light colored portion of a decoy or lure and a black surface around a LED placed adjacent a black or dark colored portion of a decoy or lure gives a decoy or lure a more natural look.

Current UV reflective paints and coatings for decoys and fish baits do a good job of creating the correct amount of UV reflectance in sunlight, but have the drawback that they are only effective if there is some sunlight with UV rays to reflect off the coated surface. This is problematic as the most productive fishing as well as the most productive hunting for waterfowl is typically experienced at dusk and dawn and on days of heavy clouds, rain and wind when there is little or no sunlight, with little to no UV light to reflect.

On a perfectly clear day with the sun at its zenith, only about 3% of the sun's UV rays are in the wavelengths that birds see, and which penetrate the atmosphere, is available to reflect on a decoy's surface. At dusk, dawn and in heavy clouds there is virtually no available UV light. The same lack of UV lighting exists with fish bait and lures. The waterproof lighting assembly described below has been developed to overcome these drawbacks.

That is, the battery powered UV lighting assembly described below is different from passive UV reflecting surfaces because the lighting assembly actively and independently produces UV light with one or more LEDs and does not require any UV light from the sun to create a realistic visual enhancement to attract fish and game with UV illuminated decoys and fish baits. The small amount of UV light produced by the lighting assembly gives a decoy or lure a natural look that can result in more waterfowl being drawn into a decoy spread pattern and more fish drawn to a fish bait.

Switching circuitry enables the UV or near UV light to be left in a steady on mode or in a slowly or rapidly flashing, pulsed or strobed mode. The slowly flashing, pulsed or strobed mode can be used on every third or fourth decoy and is most effective on cloudy and partly cloudy days as the pulsing or strobing mimics the scattering of UV light that penetrates the cloud cover (Reyleigh Scattering) and randomly reflects off one or more decoys. The lighting assembly has a distinct advantage over UV reflecting materials, UV paint and UV coatings. Namely, the lighting assembly will emit and reflect UV light off of decoys similar to the sunlight reflected off of UV coated, painted or infused decoys on sunny and partly sunny days, but also work on the days where there is cloud cover and at dusk and dawn when there is little or no UV light.

The visual effect of UV light is the same or similar on fish as it is in birds as fish also see in the UV spectrum. A UV lighting assembly for fish can be slightly different in shape and size from those used with decoys in that the lighting assemblies for attracting fish can be produced with a streamlined hydrodynamic shape, such as in the shape of a surfboard or torpedo. The surfboard or torpedo shape can pass through water at the surface or below the surface more quietly and efficiently than a rectangular shaped assembly and have little to no effect on the intended movement or action of a nearby bait or lure.

One embodiment adapted for attracting fish includes grommets at each end of the lighting assembly so it can be attached to fishing tackle such as a fishing line and a fishing leader. The internal structure of the lighting assembly can be the same as and work the same way with a bait or lure as it does with a decoy in that it can cast UV light on a live or dead bait or on a fishing lure giving the bait or lure the most realistic look possible. This technique is highly effective when fishing in murky waters where many popular fish live and feed and at deep depths where UV light is partly or completely scattered or absorbed by water and particulates in the water.

The lighting assembly describe herein produces UV light in the correct wavelengths that birds and fish see to enhance the natural look of waterfowl, turkey decoys, fish bait and fishing lures and does not rely on reflecting UV rays from the sun as required by UV reflective materials, coatings or paint. Wavelengths in the UVA range have been found well suited for attracting birds and fish. The lighting assembly can also be used on standard non-UV coated decoys and lures to create the same visual effect for birds and fish on sunny and partly sunny days as on cloudy or dark days.

The artificially produced UV light can enhance the natural look of UV reflective coated decoys and fishing lures and will not impair their natural look as the lighting assemblies do not create any additional light reflection due to the flat black or white surfaces provided around their LEDs. If the relatively low lighting level produced by a LED light is kept on in bright sunlight, it is simply washed out by the sun. By using the lighting assembly described herein, hunters with no UV coated decoys and anglers with no UV coated fish bait can inexpensively produce similar results as produced by UV coated decoys and UV coated lures on sunny and partly sunny days. Decoys, fishing baits and lures illuminated with the UV lighting assemblies can outperform decoys, fishing baits and lures with reflective coatings at times of little or no UV light production such as at dusk, dawn, in heavy clouds and in murky or deep water.

The lighting assembly can be held in a waterproof pouch formed between two elongated strips of plastic. The plastic strips can be formed or molded or otherwise provided with one or more contoured surface portions such as flexible flaps to produce a desired movement or action when moved through a body of water. One embodiment includes a peel away outer layer that covers an underlying layer of adhesive provided on an exterior surface of the pouch.

Another embodiment includes a less flexible opaque strip of plastic bonded to a clear layer of plastic. Another embodiment includes a more flexible pouch formed of two relatively flexible easily bent strips of clear or translucent plastic with or without an external adhesive layer.

Anglers having an existing collection of artificial bait and lures need not purchase relatively expensive artificial bait and lures produced with integral lighting. An existing bait or lure without lighting can be quickly and easily illuminated by simply attacking a lighting assembly as described below directly to a bait or lure with an optional adhesive layer provided on a lighting assembly. Alternatively, a lighting assembly can be attached in line with a bait or lure or rigged on a separate line adjacent to the bait or lure.

The lighting assemblies are provided with light emitting diodes (“LEDs”) that emit light in a number of different colors including white light, red light, green light, blue light, amber light, as well as light outside the visible spectrum including ultraviolet (“UV”) light, particularly in the UVA spectrum, and infrared (“IR”) light. Microcircuitry is provided on a circuit board to operate the LEDs in a number of different operating modes including a constant on mode, constant off mode, a slowly pulsed or strobed mode, a quickly pulsed or strobed mode and an optional high and low light intensity mode for one or more of the aforementioned operating modes.

One or more openings can be formed through one or more of the plastic strips that cover and protect the light assembly from shock and water damage. Grommets can be secured around the openings to reinforce the plastic at its points of attachment to fishing tackle and fishing line.

In one embodiment, one or more plastic sheets can extend in any direction from the pouch holding a lighting assembly in order to provide a point of attachment for a grommet. These extensions can be formed as flexible flaps that can pivot back and forth when moved through a body of water.

### BRIEF DESCRIPTION OF THE DRAWINGS

In the drawings:

FIG. 1 is a schematic front or plan view of a glove fitted with a compact lighting assembly in accordance with one embodiment of the disclosure;

FIG. 2 is a schematic rear or back hand view of FIG. 1;

FIG. 3 is a front view of an integral battery, light and switch circuit assembly;

FIG. 4 is a rear view of FIG. 3;

FIG. 5 is a view in a section taken along section line 5-5 of the assembly of FIG. 2 fitted within a removable casing;

FIG. 6 is a front view of an integral battery, light and switching assembly fitted within a removable mounting strip;

FIG. 7 is a view in cross section taken through section line 7-7 of FIG. 6 and showing a complementary adhesive mounting strip;

FIGS. 8 and 9 are perspective front and rear views of a glove as represented in FIGS. 1 and 2 with lighting assemblies removably secured to the glove;

FIG. 10 is a perspective view of a representative application of the glove of FIGS. 8 and 9 and showing use of a lighting assembly such as shown in FIG. 6 applied to clothing and to a helmet;

FIG. 11 is a front view of a textured translucent plastic material suitable for forming pockets or coverings over the lighting assembly of FIGS. 1 and 3;

FIG. 12 is a view of a compact lighting assembly carried by a fishing lure and other fishing tackle;

FIG. 13 is a schematic perspective view of lighting assemblies without any cover or pouch and shown approximately to scale at actual size;

FIG. 14 is an enlarged cross sectional view of a compact lighting assembly enclosed in a protective pouch and provided with an optional tactile mechanical indicator switch;

FIG. 15 is a schematic front elevation view of a tent provided with illumination by several compact lighting assemblies;

FIG. 16 is a schematic view of a shoe or boot provided with compact lighting assemblies;

FIG. 17 is an enlarged view of a compact lighting assembly adapted for use with the shoe or boot of FIG. 15;

FIG. 18 is a rear elevation view of a backpack provided with interior and exterior compact lighting assemblies;

FIG. 19 is a view similar to FIG. 14 showing the addition of a solar cell, an RFID device and a light-actuated photoswitch;

FIG. 20 is a schematic circuit diagram of one embodiment of a compact lighting assembly provided with a rechargeable battery, solar cell and light-actuated on-off switch;

FIG. 21 is a schematic circuit diagram of another embodiment of a compact lighting assembly provided with a rechargeable battery, solar cell and light-actuated on-off switch;

FIG. 22 is a view similar to FIG. 6 depicting a compact lighting assembly with an infrared light source and a visible indicator light;

FIG. 23 is a schematic circuit diagram of a circuit for use in the assembly of FIG. 22;

FIG. 24 is a view similar to FIG. 14 showing a mechanical on-off switch which provides a tactile indication of the operating states of an infrared light;

FIG. 25 is a top plan view of a compact waterproof lighting assembly constructed for attracting fish underwater;

FIG. 26 is a side view of FIG. 25;

FIG. 27 is a sectional view taken along line 27-27 in FIG. 25;

FIG. 28 is an enlarged partial side view of a contoured rear end flap formed with a curved fin or tail;

FIG. 29 is a top plan view of a lighting assembly removed from the waterproof lighting assembly of FIG. 25;

FIG. 30 is a rear plan view of FIG. 29;

FIG. 31 is a view of FIG. 29 with covering layers removed to show the arrangement of the battery and circuit board;

FIG. 32 is a sectional view taken along line 32-32 of FIG. 29;

FIG. 33 is an enlarged sectional view taken through line 33-33 of FIG. 30;

FIG. 34 is an enlarged sectional view similar to FIG. 32 showing an embodiment of a lighting assembly with two layers of shock absorbing material;

FIG. 35 is an enlarged central sectional view similar to FIG. 32 showing an embodiment of a lighting assembly having two layers of shock absorbing material and two light reflecting layers and constructed with an internal passage for reflecting light through the internal passage;

FIG. 36 is a schematic view of a typical use of two waterproof lighting assemblies used with a rod and reel and with a float and sinker for attracting fish;

FIG. 37 is a schematic view of a typical use of two waterproof lighting assemblies used with ice fishing tackle for attracting fish under the ice;

FIG. 38 is a schematic view of the use of a series of waterproof lighting assemblies coupled to a fishing dredge for attracting fish while trolling, along with an attached artificial fish bait and a free line live fish bait;

FIG. 39 is a side elevation view of a waterproof lighting assembly directly attached to an artificial fish bait, with an additional waterproof lighting assembly coupled to a swivel snap and a pair of lighting assemblies coupled to a triple swivel;

FIG. 40 is a schematic side elevation view of a waterproof lighting assembly coupled to the side of a bird decoy for attracting birds;

FIG. 41 is a schematic view of the use of one or more waterproof lighting assemblies with a dip net;

FIG. 42 is a schematic view of the use of a waterproof lighting assembly with an underwater trap attracting fish, including shellfish; and

FIG. 43 is a schematic view of a series of waterproof lighting assemblies used with a gill net.

In the various views of the drawings, like reference numerals designate like or similar parts.

### DESCRIPTION OF REPRESENTATIVE EMBODIMENTS

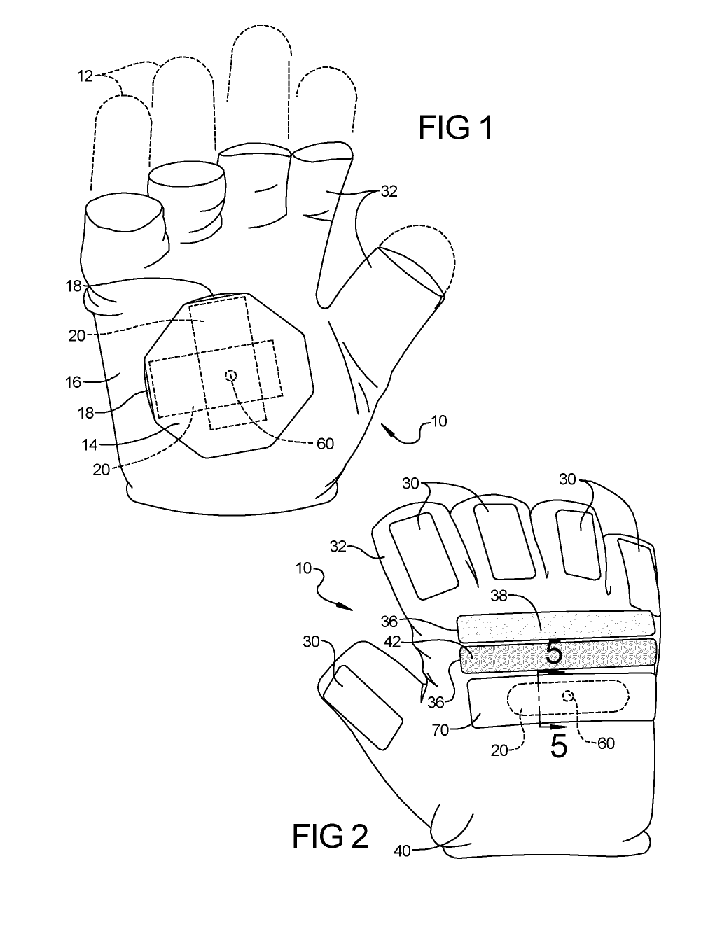

A representative application of the subject lighting assembly is shown in FIG. 1, wherein, a glove 10 is formed in a known fashion of a woven or nonwoven material such as a stretchable breathable mesh material. The glove 10 can be formed with or without fingertip portions 12. A translucent and preferably light-reflective pocket 14 is sewn, bonded or otherwise mounted to the front or palm portion 16 of the glove 10. The pocket 14 can be fabricated from a light-transmitting reflective sheet of thin flexible plastic material which may be smooth surfaced or grooved, checkered or otherwise textured to enhance light diffusion. One or more openings or slits 18 are formed along the border of the pocket 14 for snugly receiving a battery, light and switch assembly 20, as discussed further below. Assembly 20 is shown in rectangular dashed lines in FIG. 1 in two different possible mounting positions (horizontal and vertical).

The back of the glove 10 is shown in FIG. 2. Strips of light-reflective plastic or metal foil material 30 are sewn, bonded or otherwise attached to the back surface of the glove fingers 32. Attachment or mounting strips or pads 36 coated on their outer surfaces with adhesive material 38 or provided with other connectors can be removably or permanently mounted to the rear surface 40 of the glove 10 such as by sewing. The tacky adhesive coating 38 allows for the removable mounting of an integral battery, light and switch assembly 20. Alternatively, strip 36 can be provided with a hook and loop fabric fastening surface 42 to receive hook and loop fasteners provided on the back of the battery, light and switch assembly 20, or on a pocket which carries assembly 20.

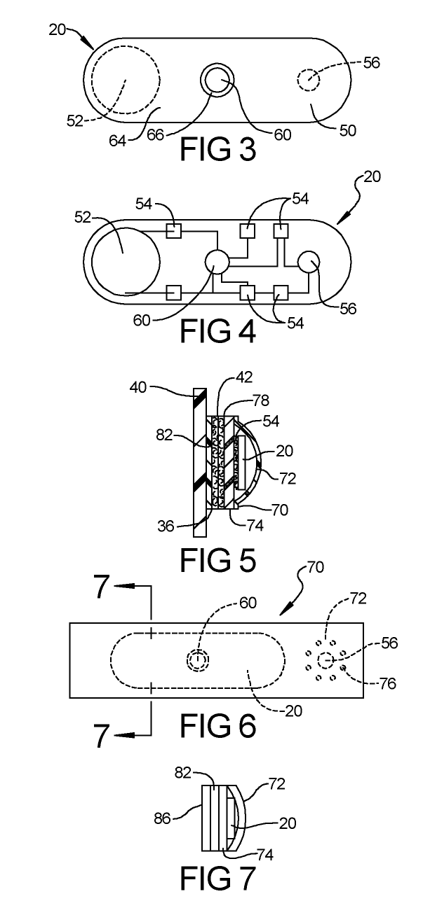

One embodiment of a compact, lightweight battery, light and switch assembly 20 is shown in FIGS. 3 and 4. A thin, semi-flexible, laminated, shiny, mirror-like, light-reflecting substantially planar sheet 50 of plastic acts as a platform, planar base or flat circuit board for holding a thin button battery 52 soldered or otherwise fixed to its front or rear surface. Sheet 50 is advantageously formed of a waterproof sheet or foil to protect microcircuitry 54 carried on platform 50. The battery 52 is electrically connected to switching microcircuitry 54 which is controlled by a user-operated button switch 56. The microcircuitry 54 can be further waterproofed with a layer of epoxy and covered by a thin sheet of rigid plastic. The rigid plastic sheet can be staked to the sheet 50 with pins or rivets to increase the strength of the laminated assembly.

In another embodiment, sheet 50 is formed with a nonreflective, black or matte black surface when the lighting assembly 20 operates with an infrared light. A flat black surface coating can be applied to planar sheet 50 to improve and enhance the detection of infrared light signatures when using an infrared viewer such as night vision goggles. The sequential actuation of button switch 56 causes the microcircuitry 54 to apply power to a light-emitting diode (LED) or other miniature electric light 60 in various operating modes. For example, a first actuation or depression of button switch 56 can trigger circuitry 54 to apply full constant power to the LED 60 for a bright constant light. A second depression of button switch 56 can trigger circuitry 54 to apply less than full constant power to the LED 60 for a longer-lasting low-power lighting.

Other sequential operating modes can include a rapidly strobed or pulsed light mode, a slowly strobed or pulsed light mode, a high power strobed or blinking light mode, a low power strobed or blinking light mode and a power off mode to turn off the LED light. The button switch 56 can be mounted on either the front or rear surface of the assembly 20 and is easily depressed and actuated by pressing down on any flexible covering material overlying button switch 56 or by directly pressing button switch 56, if it is exposed. As noted above, the button switch 56 can be located on either the front or rear surface of sheet 50. This allows an operator to actuate the button switch 56 from the front or rear surface of sheet 50, depending on the application or end use of lighting assembly 20.

To maximize the visible lighting emitted from the assembly 20, the reflective front surface 64 (FIG. 3) of the sheet 50 is formed with a highly reflective mirror-like surface finish or coating. This can take the form of a thin shiny metal foil or a layer of light-reflecting paint. An aperture or port 66 (FIG. 3) is formed through sheet 50 to allow for the unobstructed passage of light from LED light 60.

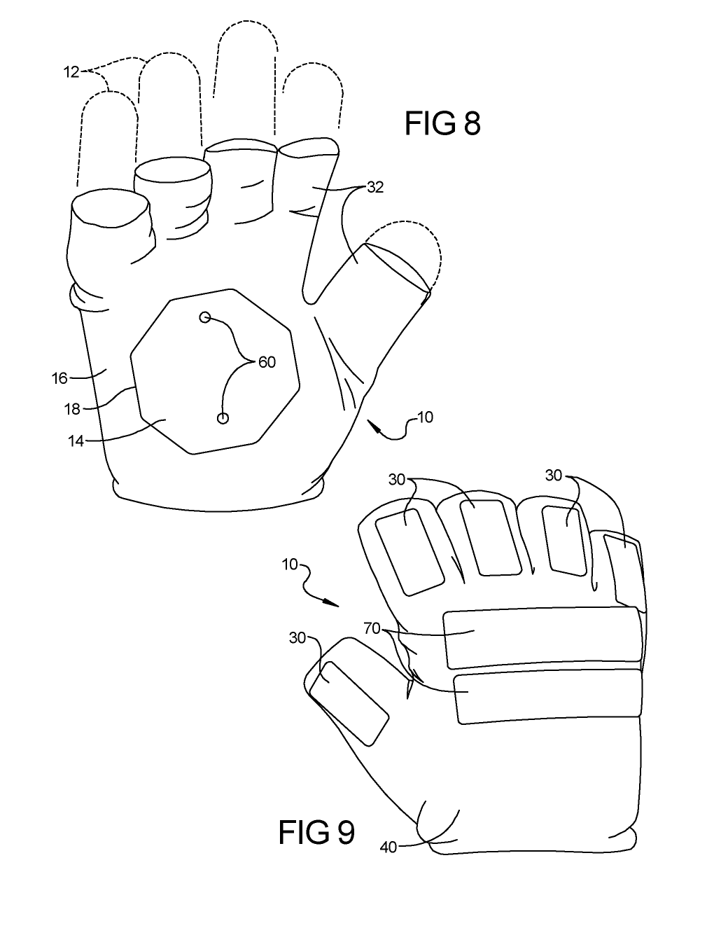

As seen in FIGS. 2, 8 and 9, lighting assembly 20 can be directly attached to the glove 10 by pressing the lighting assembly 20 against a tacky surface 38 (FIG. 2) provided on the outer surface of the glove (FIG. 2) or inserted into a translucent pocket on glove 10, such as into pocket 14 (FIGS. 1 and 8) through an opening or slit 18 communicating with the interior of pocket 14.

Another mounting method is shown in FIGS. 2, 5 and 9 where the assembly 20 is removably mounted to glove 10 with an integral adhesive layer or, as further shown, with a hook and loop releasable fabric connection. The assembly 20 can be fitted within a pouch or flexible casing 70. Pouch 70 can be hermetically sealed around the lighting assembly 20 to protect the lighting assembly 20 from shock, vibration, exposure to ambient moisture, liquids, dust and the like. The outer surface or ply 72 of casing 70 can be coated or formed of a translucent light-reflecting plastic material such as an ANSI class 2 material or simply formed of a clear sheet of plastic. This material can be used for pocket 14 (FIG. 1) as well. In the event the LED 60 becomes inoperative, surface 64 (FIG. 3) will still brightly reflect light from auto headlights, flashlights and the like to provide a secondary level of safety in those applications where visible light is provided by LED 60.

As seen in FIG. 5, the rear surface or ply 74 of casing 70 can be covered with an integral flexible hook and loop fabric material 78 of the type marketed under the brand Velcro. As further seen in FIGS. 2 and 5, an attachment strip 36 of adhesive or tacky material can be permanently or removably coupled, glued, bonded, sewn, clipped or otherwise attached or coupled to a substrate such as to the glove 10 such as on the front portion 16 (FIG. 1) or on the rear surface portion 40 as shown in FIG. 5. In FIG. 5, an adhesive backing 82 is provided on a strip of Velcro material 42 and permanently or removably attached or bonded to the rear outer surface 40 of the glove 10 for removably mounting the lighting assembly 20 to the glove 10.

Surface portion 40 in FIG. 5 can also represent the surface of any substrate such as a building or other structure or any article worn or carried by a person including a glove, a shoe, a vest, a shirt, a jacket, a hat, a helmet, pants, and belts. The outer surface portion 40 can also represent virtually any surface or substrate or article including articles worn by animals, such as collars, harnesses, clothing and the like. As detailed further below, surface or substrate 40 can represent the surface of a bird decoy or fish bait including natural and artificial fish bait.

With attachment strip 36 in place on surface 40 of glove 10, casing or pouch 70 can be quickly and easily mounted and demounted from glove 10 or any other substrate with a simple press for installation and a simple pull or peel for removal, as the hook and loop materials 78 and 42 respectively engage and disengage from each other. When the battery 52 in assembly 20 is exhausted, an operator need only remove one casing 70 with a simple pull and quickly and easily mount a fresh casing or pouch 70 onto mounting strip 36 with a simple push or press fit. The same easy mounting and demounting is afforded by the adhesive backing 82 discussed below.

It should be noted that attachment strip 36 can be permanently or removably applied to virtually any surface for receiving and holding in place a lighting assembly 20 or a lighting assembly 20 fitted in a casing or pouch 70. Once the attachment or mounting strip 36 is in place, a casing or pouch 70 with an integral lighting assembly 20 can be quickly mounted to and demounted from the attachment strip 36 and underlying substrate to which the attachment strip is applied.

As seen in FIGS. 6 and 7, a hollow hermetically-sealed and waterproof casing or pouch 70 having an adhesive backing 82 is provided with a peel-off cover 86 similar to that used on adhesive bandages of the “Band Aid” variety. Cover 86 can be removed when required and casing 70 can be adhesively mounted in the manner of an adhesive strip on virtually any surface, such as to walls, floors, articles of manufacture, trees, rocks, clothing, footwear, warning signs, police, firemen and construction helmets and other “hard hats,” as well as any other substrate such as those noted above.

In one embodiment, the length of the pouch or casing 70 is less than about two inches, i.e. about 1.75 inches (4.44 cm), the height of casing or pouch 70 is less than about one inch (2.54 cm), i.e., about 0.75 inch (1.90 cm) and the thickness through the pouch and assembly 20 as seen in FIG. 7 is less than one quarter inch, i.e., about 0.125 inch (0.317 cm). The combined weight of the pouch 70 and assembly 20 of FIGS. 6 and 7 is less than 10 grams, i.e., about 5 grams. Because of the small size and weight of this lighting assembly, a dozen or more assemblies can be conveniently carried in one's pocket to mark a trail by placing a lighting assembly 20 in at least one location or in a series of spaced-apart locations on the ground or mark other locations as desired.

One simply activates the light 60 by actuating switch 56 and placing the lighting assembly on a substrate at a position or location to be marked. If provided with an adhesive backing 82, the lighting assembly 20 can be pressed onto a desired substrate to be marked to hold the light assembly on a desired spot, such as a wall, a door, a tree, etc. Of course, one or more lighting assemblies 20 as shown in FIG. 13 need not be enclosed in a pouch 70. These simpler assemblies can be simply laid on the ground or on an object to provide a low cost lighted marker.

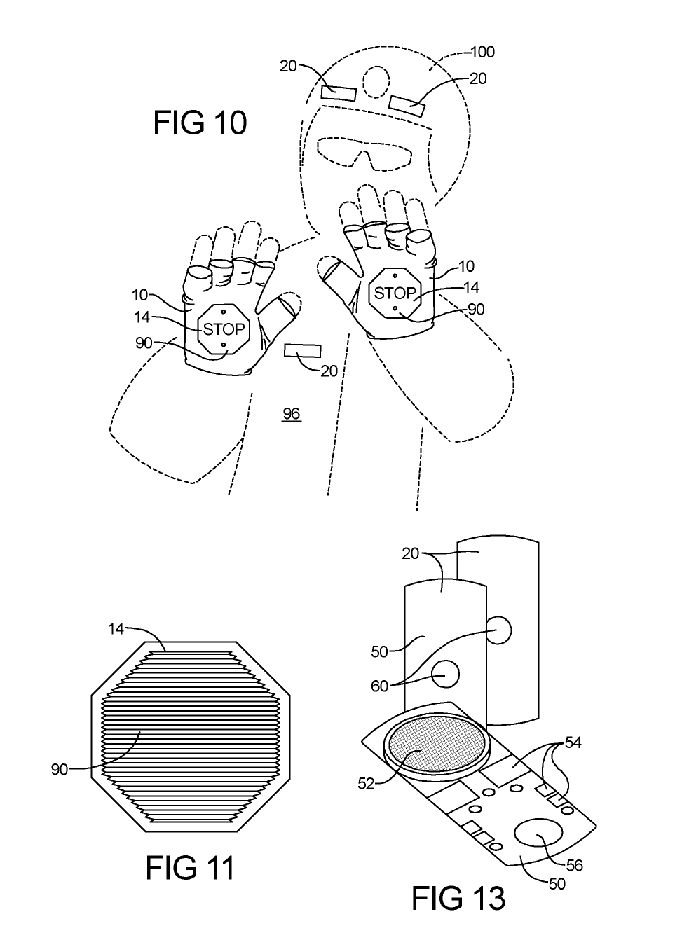

As further seen in FIG. 6, the portion of the outer surface of pouch 70 overlying the switch 56 can be textured such as with ridges and grooves or a series of dimples 76 to enable a user to easily locate and operate switch 56 solely by tactile feel without looking at pouch 70, This is most useful when operating lighting assembly 20 in the dark. As further seen in FIGS. 8 and 10, gloves 10 are provided with pockets 14 shaped as octagonal stop signs. The clear translucent plastic material of each pocket 14 can be partially colored red in the manner of a stencil around the clear letters “STOP,” which will clearly contrast with their surrounding red background. In this embodiment, two or more assemblies 20 can be inserted within each pocket 14 to provide increased lighting. As further seen in FIG. 10, the lighting assemblies 20 can be applied to a shirt, vest or jacket 96, and to a helmet 100.

To further enhance the visibility of the letters “STOP,” the inner or outer surface of the translucent material forming each pocket 14 can be formed with a grooved and ribbed surface 90 (FIG. 11) or other textured or contoured surface to diffract and/or diffuse the light from the LED's 60. The resulting light emitted from the letters “STOP” is diffused so as to enhance or more clearly depict the letters.

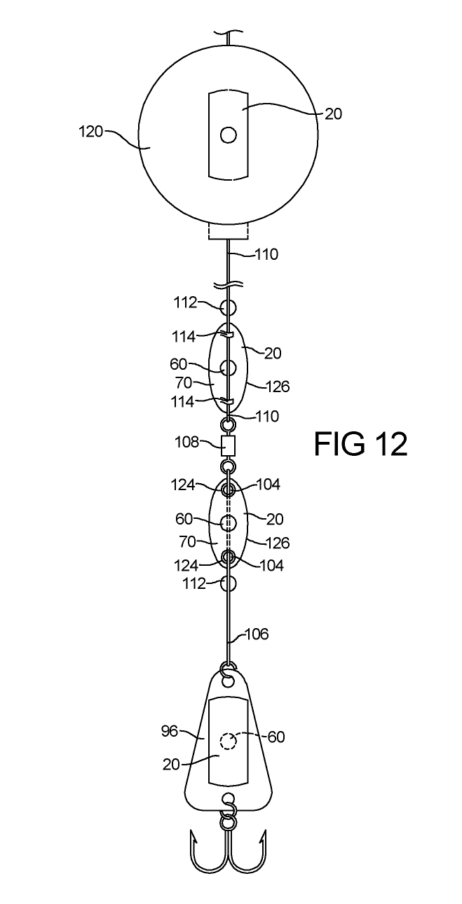

Another application of the lighting assembly 20 is shown in FIG. 12, wherein the light assembly 20 is coupled to a fishing lure 96, such as with an adhesive water-resistant attachment layer such as adhesive coatings 38 and 82 noted above. Different colored LEDs 60 can be removably or permanently coupled to a fishing lure 96, or to a bobber, float, leader, line or other tackle to attract fish to the lure or bait.

The lighting assembly 20 of FIGS. 6 and 7 is well adapted for fishing applications due to its waterproof casing or pouch 70. The flashing or strobed feature of the lighting assembly is particularly useful when applied to fishing tackle or when simply dropped in the water to attract fish. In one application, a pair of lighting assemblies 20 can be connected to each other by pressing their adhesive backings 82 together with a fishing line or leader sandwiched between the adhesive backings 82 so as to secure the pair of light assemblies to the line or leader.

As further seen in FIG. 12, a lighting assembly 20 can be formed with mounting holes 104 allowing for a threaded connection to a fishing leader 106. A swivel 108 can be used to interconnect the leader 106 to a fishing line 110. A split shot sinker 112 or other sinker or tackle can also be used to fix or otherwise locate the lighting assembly 20 on the leader 106 as well as to the line 110. Spring clips 114 can also be provided on the lighting assembly 20 to clip the leader 106 and/or line 110 to the lighting assembly 20. A lighting assembly 20 can also be coupled to a bobber or float 120 for further attracting fish, particularly at night, Different colored LED lights can be provided on different lighting assemblies 20 to match a particular colored light 60 to a particular fishing condition. Colors such as red, green, and white can be easily interchanged on fishing lures or other fishing tackle to find the best colored light for a particular fishing condition.

As further see in FIG. 12, the hydrodynamic performance of the lighting assembly 20 can be improved by forming the waterproof casing 70 as an elongated oval or cigar-shaped pouch. Grommets 124 can be crimped around the holes 104 to provide strength and tear resistance to the casings 70. The rounded ends 126 of the casings 70 provide less resistance or drag when moving through water as compared to square or blunt surfaces.

While the lighting assembly 20 described above performs well in most all environments and applications, it has been found that in some extreme environments and extremely physically demanding applications, a more rugged lighting assembly is desired. For example, in deep underwater applications and in applications where the lighting assembly 20 is subject to harsh vibrations and/or physical shocks and blows, it is desirable to provide additional protection for the circuitry 54, switch 56 and light 60.

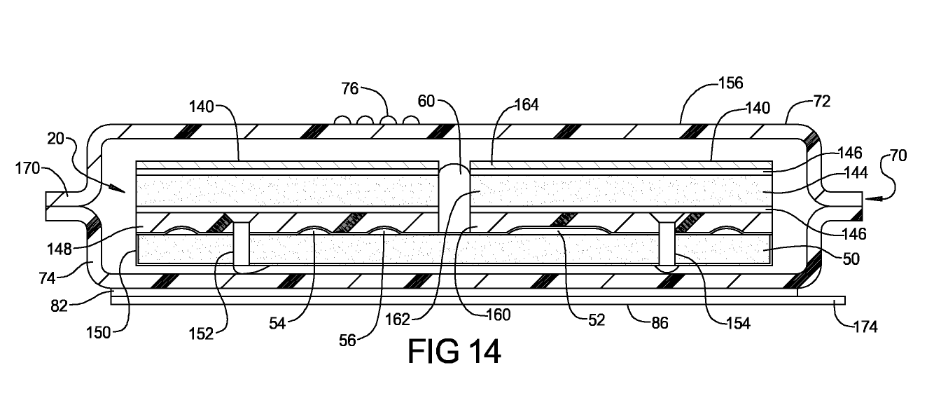

A more robust lighting assembly 20 can also be useful in many outdoor and sporting applications, such as boating, camping, hiking, running, hunting and fishing applications, and on dog collars and leashes, to name a few. The lighting assembly 20 as shown in FIG. 14 has been designed to meet these more demanding applications. It can serve as a miniature flashlight, safety warning light, signal light, light reflector and back up or emergency flashlight.

As seen in FIG. 14, a layered or laminated light assembly 20 includes a top sheet or top layer 140. Top sheet 140 can be formed of a thin sheet of highly polished metal foil, such as aluminum foil, to provide a highly light reflective outer surface portion. Top sheet 140 can have a thickness of several thousandths of an inch. This shiny outer surface portion can be used for reflecting and concentrating not only light from the LED light 60 but also external light.

For example, light from automotive headlamps can be reflected back to the light source for nighttime safety when the lighting assembly 20 is attached to or carried by a person or vehicle. This is useful for joggers, walkers, cyclists, motorcycle riders and nighttime workers. Another application for daytime use is using the reflective top sheet 140 as a signal generator for reflecting and directing sunlight to remote locations and parties, such as search parties and/or overhead aircraft or distant watercraft.

In some cases, the top sheet 140 can be formed of a dark or black light-absorbing material. One such case is when the LED light 60 is an infrared (IR) light. Alternatively, a light-reflective top sheet 140 can be covered with a layer of light absorbing material, such as a black or dark paint or coasted with a layer of light absorbing black rubber or plastic for IR applications.

The top sheet 140 overlies a protective layer 144 of shock and vibration absorbing material. Layer 144 can take the form of a sheet or strip of resilient foam material, such as high density plastic foam having a thickness of, for example, about ten to about one hundred thousandths of an inch or more. A sheet or strip of dense sponge rubber can also be used for protective layer 144. A dense nonwoven material, such as felt or a flocked fabric can also be used for layer 144. An added benefit of layer 144 is that it provides a degree of thermal insulation over an underlying circuit board to thermally protect the circuits and components on the circuit board from freezing temperatures.

The bottom of the top sheet 140 and the top of the shock-absorbing layer 144 are bonded or coupled with a layer of compliant adhesive 146. Adhesive 146 is also applied to the bottom of the vibration and shock absorbing layer 144 to bond or couple the layer 144 to the top of an underlying layer of a semi-rigid strip or sheet 148 of protective reinforcing material. Sheet 148 can take the form of a thin flexible sheet of plastic material such as a phenolic plastic material. Sheet or layer 148 can have a thickness of, for example, about ten to about thirty thousandths of an inch or more. The sheet or layer 148 can be assembled as two individual juxtaposed sheets on opposite sides of the light 60 as shown in FIG. 14 and separated by a small spacing to facilitate flexing and bending of the light assembly 20. When fully assembled, the light assembly 20 can flex up to an included angle of about 30 degrees around a hinge portion defined between the two sheets 148. This flexing helps to protect the light assemble from breakage due to moderate flexing and bending.

A platform or circuit board 50 underlies the protective strengthening sheet 148. Circuit board 50 includes the same components and microcircuitry 54 discussed above, as well as the same battery 52, LED light 60 and button switch 56. The circuit board 50 can be formed from a sheet of plastic, cardboard, fiberboard, paperboard or similar materials. Fiberboard has been found to function well due to its relative rigidity and ability to flex without cracking or breaking.

The circuit board 50 is covered, coated or encapsulated with a thin layer of adhesive or epoxy 150 to protect the microcircuitry 54 and other electrical components on the circuit board 50 from damage due to moisture, water, harmful gasses and particulates. In one example, the entire circuit board 50 and all its electrical components are coated with a thin clear layer of polyester resin epoxy. This provides waterproofing for the lighting assembly at a depth of six feet for at least thirty minutes without the use of any additional waterproofing covering. Before the epoxy coating layer on the circuit board 50 dries, the reinforcing sheet 148 can be layered over the circuit board 50 and fasteners such as stakes 152 or rivets 154 are driven through the top of the reinforcing layer 148, through the circuit board 50 and pinned to the bottom of the circuit board 50. This securely couples the reinforcing sheet 148 to the circuit board 50.

The subassembly of the reinforcing sheet 148 and circuit board 50 can be coupled or bonded to the upper layers of the light assembly 20 by pressing together the top surface of the reinforcing sheet 148 and the epoxy coated bottom surface of the shock and vibration absorbing layer 144. With the shock and vibration absorbing layer 144 bonded to the top sheet 140, the layered lighting assembly 20 is complete.

It has been found that this reinforced and shock and vibration protected embodiment of the lighting assembly 20 can perform well in most all harsh environments. While the laminated or layered construction is surprisingly strong, it is nevertheless somewhat flexible and resilient so as to resist cracking and breaking when struck or flexed. It can easily withstand all the forces and pressures applied during the repetitive actuations of the button switch 56 as the LED light 60 is turned on and off or cycled through its various operating modes.

As further seen in FIG. 14, the protective reinforcing layer 148, shock and vibration absorbing layer 144 and top layer 140 are each respectively formed with an aperture 160, 162, 164 allowing for the passage of light directed therethrough by the LED light 60. LED 60 can be recessed below, flush with or protrude from the top layer 140. It should be noted that the shock absorbing layers 144 and 146 contact and surround the outside surface of the LED light 60 so as to form a water moisture, gas and particulate barrier therebetween. In one embodiment the light 60 passes through the protective layer 148 and resilient shock absorbing layer 144 and optionally through the top layer 140.

To provide even more protection to the light assembly 20, a protective casing or pouch 70 can be provided around the light assembly 20 as further shown in FIG. 14. Casing 70 can be formed with a top layer 72 of clear polyvinylchloride (PVC) plastic and a bottom layer 74 of clear or dark or black PVC plastic material. The top and bottom layers 72, 74 are hermetically sealed or bonded completely along their peripheries 170 by adhesives and/or ultrasonic welding providing waterproof protection at depths up to 200 feet or more.

Casing 70 can be provided with a tacky but releaseable adhesive layer 82 which allows the casing 70 to be adhesively coupled to a first substrate, removed and adhesively coupled to a second, third and more different substrates or on and off the same substrate up to 50 times or more. The adhesives layer 82 is covered with a peel off tab 174. This arrangement is similar to that discussed above and operates in a similar fashion.

Tactile ridges or dimples 76 can be formed or provided on the top layer 72 of the casing 70 and aligned over the underlying button switch 56. The ridges or dimples 76 and/or the area around the ridges or dimples can be color coded to identify to a user the color of the light (or no color in the case of an IR or infrared light). For example, a red color on the casing 70 indicates a red LED light, an amber color indicates an amber LED light, a white color indicates a white LED light and a green color indicates a green LED light.

The ability to attach the light assembly 20 to virtually any substrate need not be dependent on the use of a casing 70. That is, the adhesive layer 82 and cover 86 can be applied directly to the bottom of the circuit board 50 when the light assembly 20 is used without the casing 70.

In some cases, it may be desirable to permanently attach the light assembly 20 to a substrate, such as to an article of clothing, athletic shoes, backpacks, sport clothing and safety clothing as well as many other articles. In these cases, the light assembly 20 can be directly permanently adhesively bonded to a substrate, sewn in place or attached with mechanical fasteners, such as staples and rivets. Alternatively, the entire light assembly 20 can be permanently held in place with an overlying permanent light-transmitting cover which is permanently attached or fixed to an underlying substrate with sewing, bonding, fasteners or other permanent attachment methods. In this manner, the light assembly 20 is permanently held in a pocket between the substrate and cover. Of course, an open pocket or cover can be provided on any substrate or article to allow the lighting assembly 20 to be removably and replaceably carried within the pocket on a substrate.

It can be appreciated that there are virtually endless applications for the light assembly 20 disclosed above. The light assembly 20 can be carried in one's pocket or pack as a compact emergency flashlight, as a nighttime signaling or safety warning light, or as a daytime signal mirror for reflecting sunlight from the mirror-like shiny top foil layer, or when provided with a red light, as a reading light for nighttime map reading without affecting one's night vision.

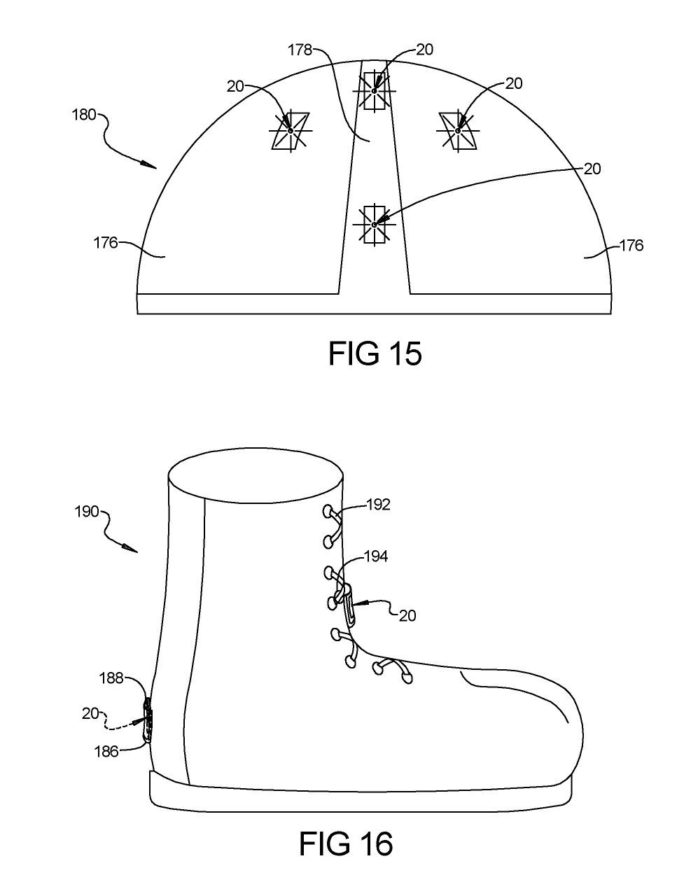

The light assembly 20 can be quickly and easily adhesively applied to one substrate, removed from the substrate and applied to a different substrate up to about fifty times. Particularly useful applications include use on the inside or outside of outdoor tents. As seen in FIG. 15, one or more light assemblies 20 can be removably or permanently attached to the exterior 176 of a tent 180 as a nighttime safety or signal light or to the interior 178 of a tent as a roof or wall light.

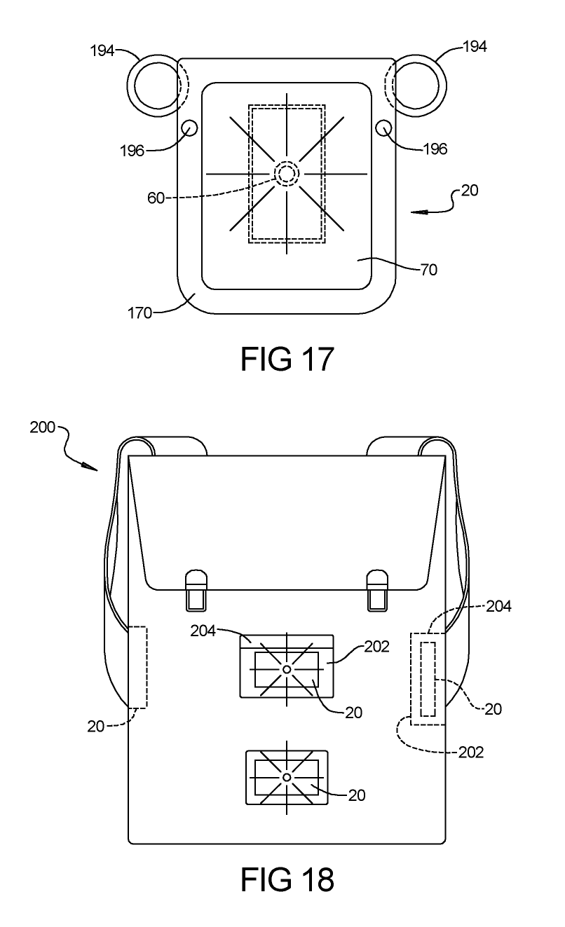

In FIG. 16, a light assembly 20 is removably inserted and removably held in an open pocket 186 having an opening 188 on a rear portion of a shoe or boot 190 for easy insertion and removal of the light assembly 20. Pocket 186 can include a “zip top” closure, for additional protection, if desired. The pocket 186 can be a sheet of clear plastic or an open mesh material. As shown in FIGS. 16 and 17, a light assembly 20 can also be removably held on the front portion of a shoe or boot 190 with a removable connector, such as with the laces 192 of the shoe or boot 190 passing through loops 194 or holes 196 provided on the periphery 170 of a casing 70. Mechanical clips can also serve the function of a removable connection, as can a luggage tag holder with a snap chain connector or a simple open top mesh pouch.

The removability allows the light assembly 20 to be detached from a substrate such as a boot, shoe or other footwear and used as a nighttime emergency flashlight or as a signaling device in the night or in daylight. This can be extremely useful for use with footwear worn in extreme environments where the need to signal for help is more likely. For example, use of the light assembly 20 on rock climbing shoes or on snowshoes provides an auxiliary safety and signaling device if required. The light assembly 20 can be held to the footwear with laces, clips or a perforated tear-away pouch.

As shown in FIG. 18, a backpack 200 is equipped with one or more light assemblies 20. A light assembly 20 can be provided on the inside and/or outside of pack 200 with a simple removable adhesive connection, as described above. Alternatively, a pocket 202 of light transmitting plastic or open mesh material can be provided on the inside and/or outside of the pack 200 to removably receive a light assembly 20 through an opening 204. In a similar fashion, virtually any compartment, such as an ice cooler, an article of luggage, a purse, a storage chest and the like can be provided with internal and/or external pockets for receiving one or more light assemblies either on their exterior or interior surface. Of course, no pockets or other holders are necessary when a light assembly 20 is adhered adhesively to such substrates.

As further seen in FIG. 14, the LED light source 60 and its associated control circuitry 54 operate using a small thin battery 52, such as a CR2016 or CR2032 button battery. These batteries can provide a constant light output for approximately 80 hours at full power and a lower residual light output for an addition amount of time up to around 200 hours. The limitation for run time is based on battery life. Solutions such as two batteries wired in series allow for longer run times, but the thickness of the lighting assembly 20 must be increased or the overall length must be increased to accommodate additional batteries. This is acceptable in some situations but at some point defeats the goal to provide a very thin waterproof, shockproof LED light source that can be conveniently carried and quickly adhered to any surface for marking or safety.

For example, the military currently has a need for a compact lightweight source of long term illumination to mark locations and items in remote areas. In accordance with another embodiment of the lighting assembly 20, this need can be met with photovoltaic solar panel technology. Small commercially available solar panels or solar “cells” measuring approximately 2 cm×2 cm (but may be larger if required) can be provided to “trickle charge” a rechargeable battery such as battery 52. Flat button cell rechargeable batteries are currently available in sizes such as CR 2016 and CR 2032 noted above.

Solar panel technology has evolved and improved over the past few years so that the panels are smaller, thinner and more rugged and can now provide a means to re-charge a thin rechargeable battery 52 to provide long run times for the lighting assemblies 20.

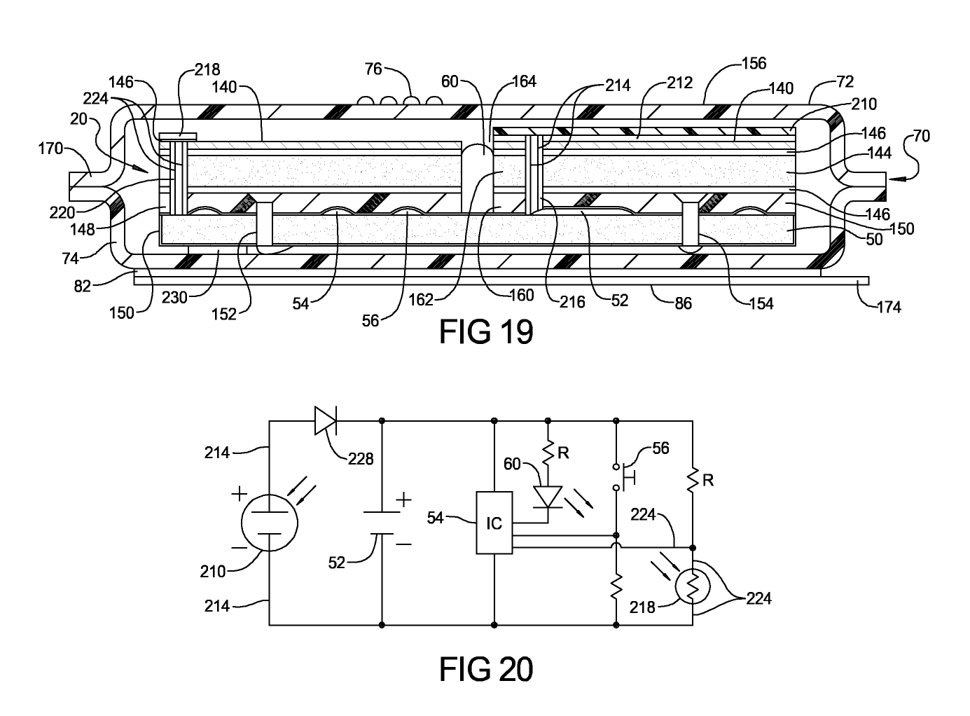

As seen in FIG. 19, a solar panel 210 is adhered to the reflective top surface of the top layer 140 by a permanent waterproof adhesive 212. Power from the solar panel 210 is sent via electrical leads 214 directly to the battery 52 through a small hole 216 under the panel. The waterproof adhesive 212 is the same or similar to the waterproof epoxy that is used to bond the circuit board 50 to the protective plate or layer 148, namely, a polyester resin epoxy.

The lighting assembly 20 with the affixed solar panel 210 is encased in a PVC pouch or casing 70 that keeps dust, dirt, water, mud etc. away from the LED/circuit/battery unit. A thin-walled PVC pouch can last for well over 500 hours when subjected to harsh elements. This life can be increased by using a higher grade of the PVC material that is slightly thicker and UV ray resistant. In this case, the run time of the LED is limited only by battery life.

The use of a small solar panel or solar cell 210 to “trickle charge” the rechargeable battery 52 provides extended operating life of the lighting assembly 20 from two to five years of service and longer as the technology for both solar panel and battery technology improves.

While this solar powered lighting assembly 20 has direct applications for the military, there is also a major advantage in the consumer market for all of the current uses of an extended life lighting assembly 20 with the added benefit of thousands of hours of runtime rather than hundreds of hours of runtime without a solar panel battery charger.

The use of a solar panel or solar cell 210 on a lighting assembly 20 is “green” or sustainable in that the current lighting systems are disposable after 100 hours or so of use compared to years of use with a rechargeable lighting assembly 20. Moreover, the cost per hour of runtime can be reduced to fractions of a cent.

The use of solar panels or solar cells 210 on the a lighting assembly 20 provides a renewable “green” energy product that costs much less than the current disposable battery lighting systems and other light sources such as chemical lights sticks that must be disposed of after only a few hours of use.

As further shown in FIGS. 19 and 20, the lighting assemblies 20 described above can be provided with a conventional light-actuated photo switch 218 wired to the microcircuitry 54. The light-actuated switch can take the form of a photoresistor, a photocell, a photodiode, a phototransistor or any similar light-actuated switch or light sensor. The technology for light-actuated switches has improved so that their size is small and thin enough to fit onto the top portion of the top layer 140 of a lighting assembly 20. The photo switch 218 can be held in place by an insulating epoxy resin, such as adhesive 146, with the top layer 140 formed with an aperture or opening cut to closely surround or underlie the light-actuated switch 218. A hole 220 through the layers 140-150 allows electrical leads 224 from switch 218 to connect with the microcircuitry 54 on the circuit board 50.

The microcircuitry 54 can take the form of a programmable controller or microcontroller to perform the lighting functions and operations as disclosed above. For example, a PICI6F506 microcontroller available from Microchip Technology Inc. of Chandler, Ariz., or any of a number of similar microcontrollers can be easily programmed to provide bright, dim, strobed and constant light output from one or more LEDs 60. Inputs to the microcircuitry 54 from the switch 56 select a particular operating mode. When a light-actuated switch 218 is used as an input to the microcircuitry 54, the LED 60 will only operate under predetermined levels of darkness which can be programmed into the microcircuitry 54.

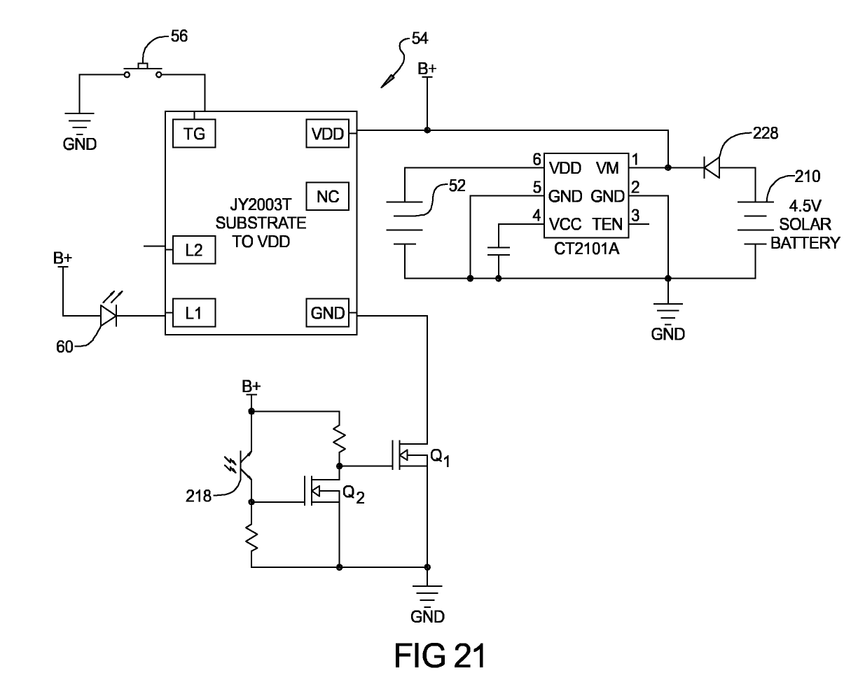

An alternative to the circuit of FIG. 20 and a more detailed circuit diagram is shown in FIG. 21 wherein details of the operating modes and circuit components are provided. A different micro-controller is used, but the functions of the solar charged lighting assembly are essentially the same as described above.

When a particular mode of operation of LED 60 is turned off by the light-actuated switch 218 due to the level of ambient light reaching a predetermined brightness, that same operating mode will be returned to operation when the level of ambient light decreases to a predetermined level of darkness. A diode 228 (FIG. 20) can be placed between the solar cell or solar panel 210 and the battery 52 to prevent battery discharge through the solar cell or solar panel 210 during periods of darkness.

The light-actuated switch 218 is first incorporated into the body of the lighting assembly 20 and then encased in a hermetically sealed pouch 70. This sealed unit is very rugged and virtually impervious to outside environmental conditions.

The light-actuated switch 218 wired as shown in FIG. 20 along with the switch 56 allows a single rechargeable battery to recharge more efficiently from the solar panel 210 as the switch 56 cuts off the light output from the LED 60 during daylight hours when the LED light 60 is not typically needed, i.e. from dawn to dusk. Because the LED is not powered at this time, the battery recharges faster. The lighting assembly 20 will operate in whichever switch mode it is left in when the outside ambient light dims down to a low lux level that is equivalent to dusk or to a very cloudy day or to a heavy sand storm. The addition of a light-actuated switch 218 can increase the operational battery run time up to 200% or more.

In some applications, it has been found advantageous to increase the size of the lighting assembly 20 to 5″×3″×/2″, for example, to include several LED lights of either the same or varied colors and/or to accommodate multiple batteries that are wired in series to act as a power storage bank. There can be as few as two or as many as twelve batteries depending on the size and thickness of the batteries as the batteries can be double or even tripled stacked. The operational run time of a stacked battery embodiment can be several years depending on the light output. Another advantage is that the battery bank can serve to power very bright short bursts of light.

All other features of the enlarged stacked battery lighting assembly 20 can be the same as described above, except the package size of pouch 70 is bigger and thicker but can still be stuck on the surface of a building, tree or other object to act a marker or signal beacon. This larger package allows for multiple LEDs of the same color or various colors and can be set to a fast strobe, slow strobe, steady or constant on and steady or constant off or can be pre-programmed to operate in a specific flashing sequence.

As further seen in FIG. 19, another beneficial addition to the light assembly 20 is an RFID chip 230 or radio frequency identifying device supported by the circuit board 50 that allows an operator to keep track of the location of the lighting assembly 20 with easy to use existing technology. This is a major advantage if a large number of lighting assemblies 20 are deployed in the field. An example of this would be to mark a mine field, landing strip, swamp etc.

As noted above, police and military operations can call for the use of infrared lighting assemblies, such as lighting assemblies 20. In order to guard against the unintended activation and illumination of an infrared LED 60 and to inform a user without IR viewing equipment of the operating state of a lighting assembly, a separate visual indicator can be provided on a lighting assembly 20. Such an indicator can visually signal a user without the aid of IR viewing equipment that the LED 60 is drawing power and to turn off the LED when it is not needed.

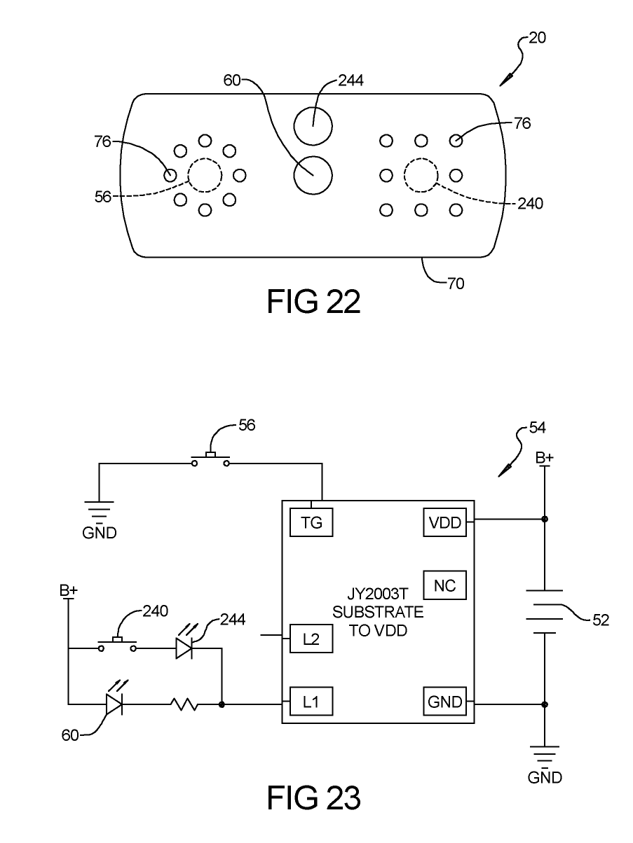

As seen in FIG. 22, a compact lighting assembly 20 constructed in accordance with any of the embodiments discussed above can be provided with an IR LED 60 which is operated by a switch 56, as further discussed above. A second switch 240 is provided to operate a second LED 244 that provides visible light. The shape, pattern, indicia or surface texture 76 of the pouch 70 overlying switch 56 can be different from that overlying switch 240 to aid a user in selecting the proper switch and differentiating between them.

The visible light LED 244 is arranged in a parallel electrical circuit with the IR LED 60. The second switch 240 can take the form of a normally open momentary contact switch arranged in series with the LED 244. When the momentary switch 240 is depressed by a user, the voltage, if any, driving the IR LED 60 will also drive the visible LED 244 and provide a visible indication to the user whether the IR LED 60 is operating or if it is off.

Not only will a user know whether the IR LED is on or off, but the operating mode of the IR LED 60 will be duplicated by the visible LED 244. If the IR LED 60 can be selectively driven in a high intensity or low intensity mode, then the visible LED 244 will also be driven in the same modes. If the IR LED 60 is constantly on or off, the visible LED 244 will be constantly on or off. If the IR LED 60 is in a constant on mode or a pulsed or strobed mode, then the visible LED 244 will likewise operate in a constant on mode or a pulsed or strobed mode. A schematic circuit diagram of one embodiment suitable for use with the lighting system of FIG. 22 is shown in FIG. 23.

It should be noted that instead of providing a visual indication or signal to a user with LED 60, an audible, tactile or vibrating signal can be provided so as not to alert others with a visible light. This can be important in stealth nighttime operations. For example, a low volume audible signal can be provided by substituting a small acoustic speaker in place of the LED 244. Alternatively, a small electromechanical vibrator can be substituted for the LED 244.

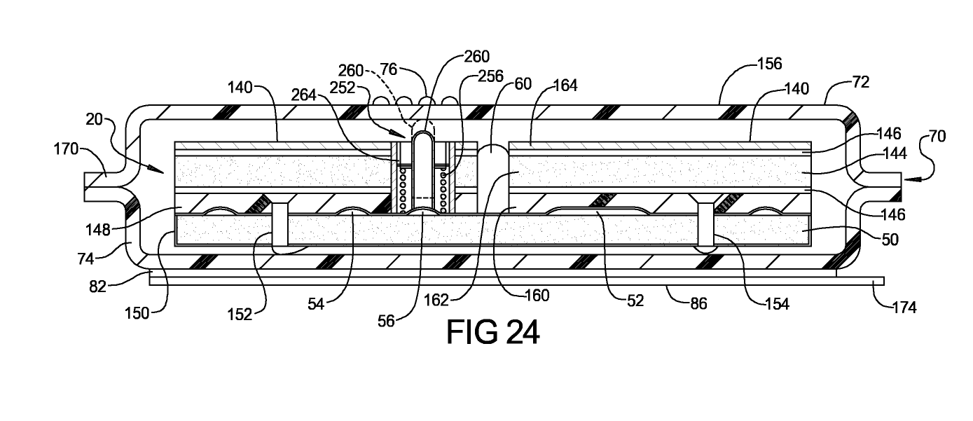

As seen in FIG. 24, a two position latching switch 252 is spring biased upwardly toward the top layer 72 of the pouch 70. Spring 256 pushes plunger 260 upwardly against the inside surface of the top layer 72 with a relatively strong force. When a user pushes downwardly on the dimples 76 of pouch 70 to activate switch 56 as shown in an at rest position dashed lines in FIG. 24, the user can immediately feel the resistance of the plunger 260 as it moves downwardly to engage switch 56 and latch into an actuated position.

Once switch 56 is activated by the plunger 260, the IR LED 60 is activated while the plunger 260 remains in a depressed position as shown in solid lines in FIG. 24. If a user subsequently wants to know if the IR LED 60 is activated, the dimples on top layer 72 are depressed. If there is no immediate resistance, the IR LED 60 is drawing power. If resistance is immediately encountered, the IR LED 60 is off.

When a user further depresses the top layer downwardly, the top of the plunger 260 is engaged and depressed slightly downwardly to unlatch the plunger, deactivate switch 56 and turn off the IR LED 60. A latching mechanism 264 of conventional design (similar to that found in ball point pens), releases the plunger 260 and allows it to return to its normally off position shown in dashed lines.

A list of potential applications and substrates for the light assemblies 20 includes:

Alert Devices; Steady or Strobe Mode

Aircraft: 1. Used by pilots for backup cockpit light and on the underside of a visor for chart reading. 2. Used in a downed plane for emergency day/night signaling and trail marking.

Automobiles: 1. Compartment light glove box, trunk, engine compartment. 2. Emergency signaling if a vehicle is disabled and as a portable light. 3. Wheel well light to light up rims with chemical luminescent coating.

Aquariums: Light in reefs and tight places.

Babies: 1. Nightlight 2. Crib light 3. Stroller light 4. Educational purposes for teaching colors.

Backpacks: 1. Use as an internal pack light when looking for articles inside a pack in low light. 2. Use as a portable light and as a trail marker, camp marker or day/night emergency signaling system.

Baseball Bats: 1. Use on a bat for training in low light. 2. Dramatic effect in night games.

Barbeque: 1. Grill light 2. Grilling tools

Belts: Fashion use and use as a safety marker.

Bicycles: 1. Use on bike frames and wheels for safety, as well as worn by a rider on a helmet, shoes and apparel. 2. Use as portable lighting and for marking ride routes.

Boating/Marine: 1. Use for increased visibility in small watercraft and personal flotation devices (PFDs) in steady mode or strobe or use as an emergency flashlight or compartment light. 2. Running lights or port, starboard, stern and bow lights. 3. Use on paddles for increased visibility.

Boomerangs: Apply to surface for effect in the dark and easy retrieval.

Boots: 1. Safety markers in clear or reflective pouches on backs of boots, shoes, running shoes, cycling shoes, hunting boots, ski boots and snowboard boots. 2. For visibility with use as an emergency light, trail marker and/or day/night signaling system. 3. Use in luggage tag type pouch attached to boot laces as an emergency light for a day or night signaling system that is always available when worn.

Bowling: Use to mark lanes

Coolers (hard sided, soft sided and insulted lunch bags): 1. Use as an interior light. 2. Use to mark contents with or without light color coding. 3. Use as a marker particularly if a cooler is used as an emergency flotation device.

Camping: 1. Trail markers 2. Tent lights (interior/exterior) 3. Camp perimeter markers 4. Mini flashlight 5. Applied to cooking tools to help locate at night. 6. Applied to hunting boots for night hiking.

Construction: 1. Cones and barriers 2. Hard hats with color coding to identify different workers and personnel. 3. Mark structures with non-conformity to plans by inspectors. 4. Mark hallway areas if no power or light.

Costumes: 1. Halloween costumes for dramatic effect (i.e. spaceman, monster, princess) steady or strobe light keeps children and parents safe at night when walking in streets.

Crime Scenes: 1. Mark crime scene tape 3. Mark specific areas by color 3. Color code personnel at a crime scene.

Decoys: 1. Attracting birds.

Diving: 1. Dive gear to mark at night 2. Lines to mark depth 3. Underwater trail markers.

Dogs: 1. Dog pet leashes collars for road safety. 2. Hunting dog collars to mark specific dogs by color code when night hunting. 3. Dog sectors by color code attached to trees.

Dealers: Car, Auto, Boat, Motorcycle trailers.

Dueling: Sword fighting; training and dramatic effect in the dark.

Emergency Lighting: Power outages of home lights 2. Deck lights 3. Alert lights indicating help is needed 4. Step lights.

Fishing: 1. Illuminating bait of all types including artificial and naturally occurring fish bait. 2. Attracting fish of all types to fishing tackle, fishing nets and fishing traps to catch fish, crabs, shrimp and lobster.

Firearms: 1. Light to check if round in chamber 2. Aid in night sights illumination

Firemen: 1. Helmets 2. Mark rooms. 3. Traffic cones.

Garages: Lights for marking parking spaces.

Incident Command: 1. Use to mark areas 2. Mark for triage 3. Mark homes for evacuation.

Kayaking: 1. Use on life jackets and personal flotation devices (PFDs). 2. Use on paddles for night paddling. 3. Use as navigation lights. 4. Use as compartment lights.

Tree Limbing: 1. Mark tree limbs 2. Mark wires near tree limits.

Menu Lights: Operating lights when car, boat, motorcycle and ATV lights fail.

Personnel: Light for different operation for any factory, construction site etc.

Power Outages: Use emergency backup lighting.

Quality Control: Applied to production that is defective.

Road Constructions: 1. Use for night cones. 2. Hard hats 3. Safety vests.

Street Signs: Use on street signs during power outages/storms.

Uniforms: 1. Public safety 2. Military.

As noted above in conjunction with FIG. 12, a lighting assembly 20 can be used to attract fish to a fish bait such as a fishing lure. As used hereinafter, the term fish bait is intended to include any and all types of bait for attracting and/or catching fish including naturally occurring live and dead bait and artificial bait such as fishing hooks, fishing lures, artificial flies, soft plastic baits and hard baits and hookless tackle such as teasers. As further used hereinafter, the term fish is intended to include all aquatic life, particularly fish having gills, as well as shellfish such as lobster, crab and shrimp.

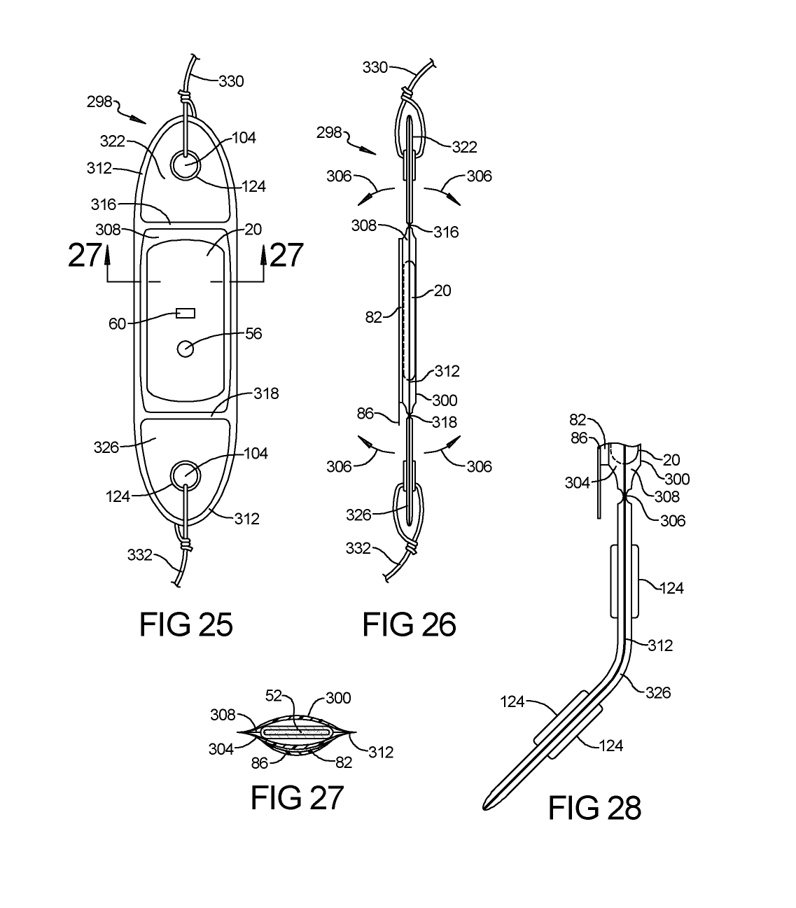

While any of the previously described waterproofed lighting assemblies 20 can be used for attracting fish, a lighting assembly 20 designed particularly for use with fishing tackle, fishing nets, fishing traps, and fishing bait of all types is shown in FIGS. 25, 26 and 27. In this embodiment, a lighting assembly 20 such as described above or as modified as described further below, is held between two sheets or strips of flexible plastic to form a waterproof lighting assembly 298.

A first or top sheet 300, the same or similar to sheet or top ply 72 described above, is formed of a thin flexible clear transparent plastic or a textured translucent plastic to allow light from an LED 60 to pass therethrough. A second or bottom sheet 304, the same or similar to the sheet or ply 74 described above, is bonded to the top sheet 300 to form a waterproof chamber 308 around a lighting assembly 20. Virtually no air is sealed in the chamber 308. The bottom sheet 304 can also be formed of clear transparent plastic or textured translucent plastic. Alternatively, the bottom sheet 304 can be formed of an opaque plastic as is represented in FIGS. 25-27.

The top and bottom sheets 300, 304 are bonded together along their outer edges forming a waterproof outer peripheral seal 312. Seal 312 can be formed by heat bonding, ultrasonic bonding or welding, adhesive bonding or any other type of waterproof sealing process.

A hinge, such as a living hinge 316, can be formed transversely across the top and bottom sheets 300, 304 adjacent to one end of the light assembly 20. Hinge 316 can be formed by heat and pressure to produce a secondary waterproof bond and seal serving as a living hinge 316. A similar optional hinge 318 can be formed adjacent the other end of the light assembly 20 forming an additional waterproof bond and seal.

The hinges 316 and 318 separate the waterproof chamber 308 and the lighting assembly 20 from one or more flexible pivotable end flaps. A first end flap 322 is formed from a first extended end portion of one or both sheets 300, 304. Extended end portions of both sheets 300, 304 are shown in FIGS. 25-28 as forming the first laminated end flap 322 as well as a second optional laminated end flap 326 extending from the opposite end of the chamber 308. Virtually no air is sealed between the end portions of the sheets 300, 304 which form the end flaps 322, 326. The hinges 316 and 318 can be bonded together with a thin cross section about one millimeter or less allowing the flaps 322, 326 to freely flex back and forth as indicated by directional arrows 306 in FIG. 26.

The pivoting flexible flaps 316, 318 can be formed or molded with virtually any desired two or three dimensional shape such as the substantially two dimensional rounded or bullet shaped planar flaps shown in FIGS. 25 and 26. In the embodiment shown in FIG. 28, the rear flap 318 can be formed with a curved or elbow-shaped profile to provide a desired movement to the waterproof lighting assembly 298 when it is moved through a body of water. Bends, twists, curls, slots and other shapes can be easily molded on either or both end flaps 322, 326 to provide a desired hydrodynamic movement or effect.

Apertures 104 can be formed through one or both flaps 322, 326 and reinforced with rust resistant grommets 124. The reinforced apertures 104 can serve as points of attachment for coupling a waterproof lighting assembly 298 to virtually any type of fishing tackle and/or fish bait. For example, as shown in FIGS. 25 and 26, a simple fishing line 330 similar to fishing line 110 in FIG. 12 is connected to one end flap 322 and a fishing leader 332 similar to leader 106 in FIG. 12 is connected to the opposite end flap 326. Any type of fishing tackle can be coupled to either or both of the fishing line and fishing leader.

When forming the seals and hinges 312, 316, 318 around the lighting assembly 20, virtually all the ambient air is removed or squeezed out of the chamber 308 and from between the sheets 300, 304 forming the end flaps 322, 326. This not only reduces the thickness and hydrodynamic drag of the resulting encapsulated lighting assembly 20, it also increases the depth to which the waterproof lighting assembly 298 can function, potentially down to several thousand feet below the surface of the ocean. At these extreme depths, the waterproof lighting assembly 298 can be used effectively in place of chemical light sticks for attracting bottom fish such as swordfish. Of course, the waterproof lighting assembly 298 can be used in combination with chemical light sticks or as a substitute replacement for chemical light sticks at any depth.

By minimizing the thickness or cross section of the chamber 308, the waterproof lighting assembly 298 can be applied directly to the outer surface of a fish bait without noticeably disturbing the natural movement of the fish bait through a body of water. In one embodiment, the maximum thickness of a waterproof lighting assembly 298 across the chamber 308 can be less than four millimeters thick and less than 0.6 millimeters thick through the double layered end flaps 322, 326. In one embodiment, the width of a waterproof lighting assembly 298 can be about 25 millimeters (about one inch) across and about 107 millimeters (about four and one fourth inch) long and weigh less than about ten grams, namely, only about five or six grams.

As further shown in FIG. 25, the encapsulated lighting assembly 20 includes a LED 60 and a button switch 56 actuated by pressing or squeezing the switch 56 through the top and/or bottom sheets 300, 304 as described in the previous embodiments. Repeatedly pressing the switch 56 cycles the LED 60 through any number of operating modes such as constant on, constant off and fast and slow strobed modes or any of the modes noted above.

The LED 60 can emit any type or color of light. However, LEDs emitting red and green light have performed well in attracting fish to various fish baits. LEDs emitting UV light work well in attracting fish to most all fish baits, and work particularly well when used with fish baits having UV reflecting surface coatings and/or UV enhancing embedded or infused materials.

As described above in the previous embodiments, the waterproof lighting system 298 can include a tacky or gummy adhesive layer 82 such as shown in FIGS. 25-28. A peel-off cover 86 can be easily removed to expose the adhesive layer 82.

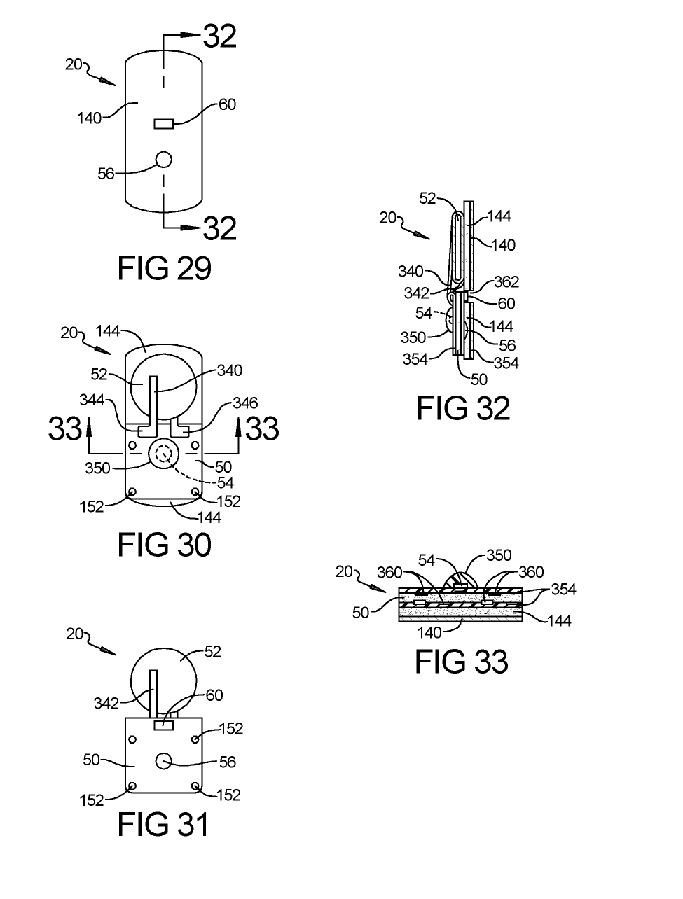

Additional details of a lighting assembly 20 used in a waterproof lighting assembly 298 are shown in FIGS. 29-35 wherein a circuit board 50 has been reduced in length by about 50% as compared to prior embodiments. In this case, the circuit board 50 does not extend under the battery 52. Rather, the battery 52 is flexibly connected to the circuit board 52 by flexible and bendable metal spring arm connectors 340 and 342.

The connectors 340 and 342 can be pressed, staked, heat bonded, soldered or otherwise electrically connected to the battery and connected to the circuit board 50 at solder points 344, 346. Because the connectors 340 and 342 are flexible, they form a flexible hinge between the battery 52 and the circuit board 50. This allows the lighting assembly 20 to bend and flex back and forth within chamber 308 over an included angle of up to about thirty degrees without sustaining any structural damage. This protects the lighting assembly from damage due to harsh use outdoors and from rough handling during shipping.

FIGS. 30 and 32 show a protective shock absorbing layer of rubber or elastomeric material 144 adhesively attached to the bottom surfaces of the battery 52 and circuit board 50 on a lighting assembly 20. As further seen in FIG. 30, a microcircuit or “microchip” 54 is mounted on the top of the circuit board 50 and covered or “potted” with a drop of hardened enamel, glue or epoxy 350. The microcircuit 54 controls the operation of the LED 60 upon receiving inputs from the switch 56, as described above.

As seen in FIG. 32, an opening or aperture 362 is formed through the shock absorbing layer 144 and through a thin light reflecting foil layer 140 about 0.3 millimeters thick. The light reflecting layer 140 can be formed from a thin sheet of silvered foil having a mirror finish on both sides. The aperture 362 can be quite small, such as about 3 millimeters long and about 2 millimeters high, yet allow substantially the full amount of light emitted from the LED 60 to pass through the aperture and through the transparent top sheet 308.

The shock absorbing spongy layer 144 has been removed from FIG. 31 for the purpose of showing the underlying top surfaces of the battery 52 and circuit board 50. The top and bottom surfaces of the circuit board 50 support additional circuitry 360 (FIG. 33) which is covered with thin layers of plastic waterproofing and electrical insulating material 354.

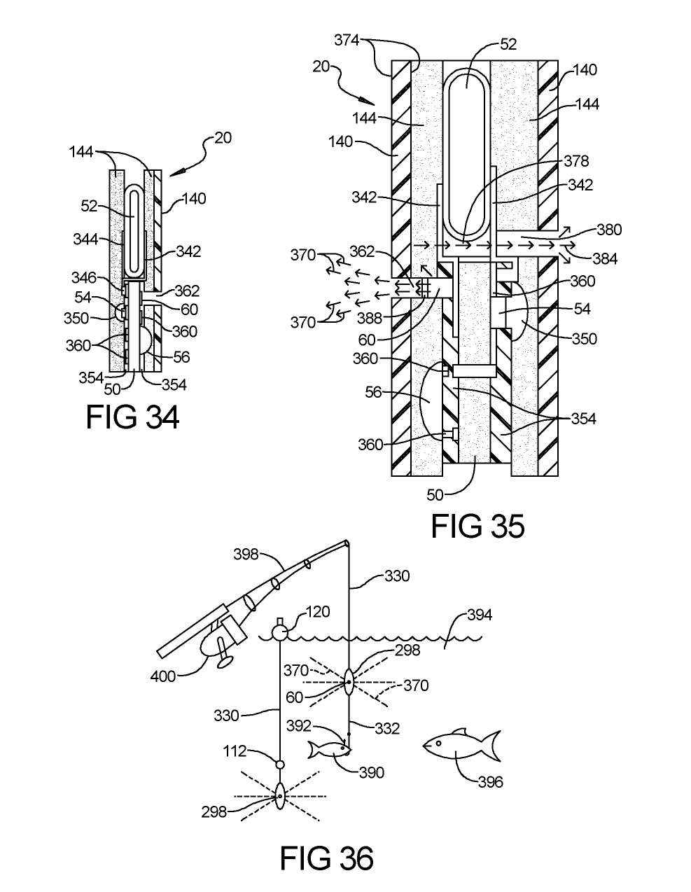

To provide greater resistance to shock and rough handling, an additional layer of shock absorbing spongy elastomeric or rubbery material 144 can be adhesively joined to the bottom side of the light assembly 20, as shown in FIG. 34. This lighting assembly 20 is then encapsulated between a pair of mutually bonded sheets 300, 304 as described above to form a waterproof lighting assembly 298.

Another embodiment of a lighting assembly 20 for use with or without a waterproof lighting assembly 298 is shown in FIG. 35 wherein light rays 370 from a LED 60 are emitted directly out of the aperture 362 on the top side or front of the lighting assembly 20 and reflected indirectly out of the bottom side or back of the lighting assembly 20. This dual beam lighting assembly is achieved by providing a highly polished mirror surface 374 on at least the inner face of the top light reflecting layer 140 and preferably on both sides of the reflecting layer 140 adjacent to the LED 60.

As further shown in FIG. 35, a portion of the light rays 370 passes through the open cell or other translucent shock absorbing material 144 and is reflected back through an open space 378 between the battery 52 and the circuit board 50. Alternatively, a portion of the light rays 370 can be reflected directly from the light reflecting layer 140 by removing the shock absorbing material adjacent to the LED 60.

A second aperture 380 is formed through the bottom shock absorbing layer 144 and extending into the open space 370 to provide a clear path for the reflected light 384 to exit the bottom surface of the lighting assembly 20. An optional bottom reflective layer 140 can be provided over the bottom shock absorbing layer 144. The bottom reflective layer 140 can be provided with a mirror finish on just its exterior surface or on both its exterior and interior surfaces. The aperture 384 is then extended through this second bottom reflective layer as shown in FIG. 35.

The lighting assembly 20 of FIG. 35 is encapsulated between top and bottom sheets, 300, 304 of clear transparent or translucent plastic to form a waterproof lighting assembly 298. This lighting assembly 20 can be provided with a LED 60 that emits any desired wavelength or color of light. If the LED 60 emits only UV light, a user cannot see it and cannot tell if the LED is on or off. To remedy this problem, a thin coating or layer 388 of material can be provided on or adjacent to the LED 60 to provide an indication within the visible spectrum of the operating state of the LED 60. The coating or layer 388 emits visible light when illuminated with UV light. The coating or layer 388 can include a small amount of phosphor that glows dimly upon receiving UV light.

FIGS. 36-43 show representative examples of the use of a waterproof lighting assembly 298 with different types of tackle and fish bait. In FIG. 36, a lighting assembly 298 is coupled on one end to a fishing line 330 and on the other end to a leader 332. A fish bait 390 is held on the leader 332 with a fish hook 392. The LED 60 is turned on by pressing on the flexible cover sheets as described above. The fish bait 390 is then lowered into a body of water 394 followed by or preceded by the waterproof lighting assembly 298 with the activated LED emitting light for attracting a fish 396.

As further seen in FIG. 36, light rays 370 emitted from the LED 60 are shown attracting the fish 396 to the fish bait 390. The fishing line 330 can be attached to virtually any fishing tackle such as a rod 398 and reel 400. Additional attraction for catching fish can be provided by placing an additional waterproof lighting assembly 298 in the body of water 394 adjacent to the fish bait 390 at the same depth or at greater or lesser depths. A sinker 112 can be attached to a fishing line 330 adjacent to a submerged waterproof lighting assembly 298 coupled to a fish bait 390. A bobber or float 120 can hold the sinker 112 and waterproof lighting assembly 298 at any desired depth.

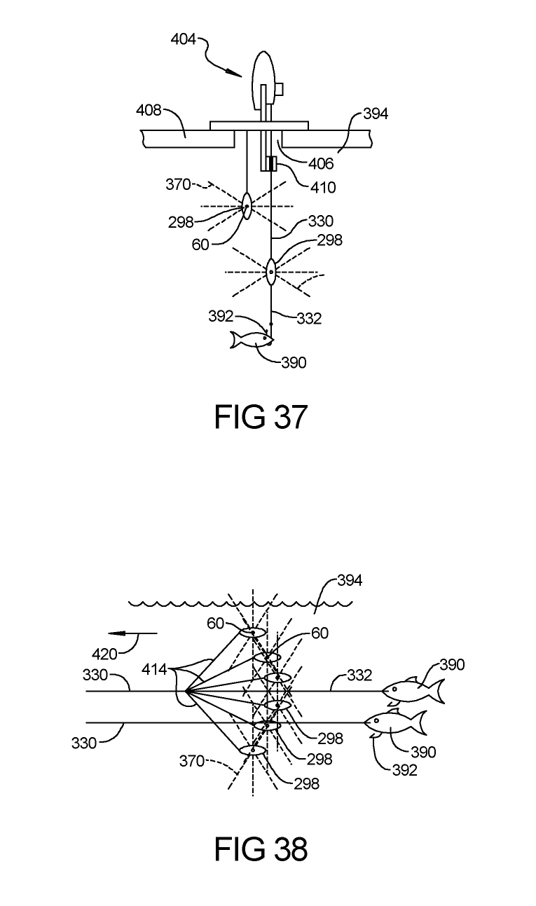

A similar arrangement for ice fishing is shown in FIG. 37 wherein a “tip up” assembly 404 is positioned over a hole 406 cut through a layer of ice 408. One or more waterproof lighting assemblies 298 can be lowered through the hole 406 to attract fish to the fish bait 390 held on line 330 descending from spool 410.

FIG. 38 shows the use of an array of waterproof lighting assemblies 298 connected to a fishing “dredge” 412 for enhancing the performance of the dredge. The dredge 412 includes an array of stiff lines or thin rods 414 which are arranged in a spoked conical pattern to simulate a school of bait fish for attracting larger fish. A fish bait 390 can be attached to the dredge 412 or trolled behind or adjacent to the dredge as the dredge and fish bait are pulled through a body of water 394 in the direction of arrow 420.

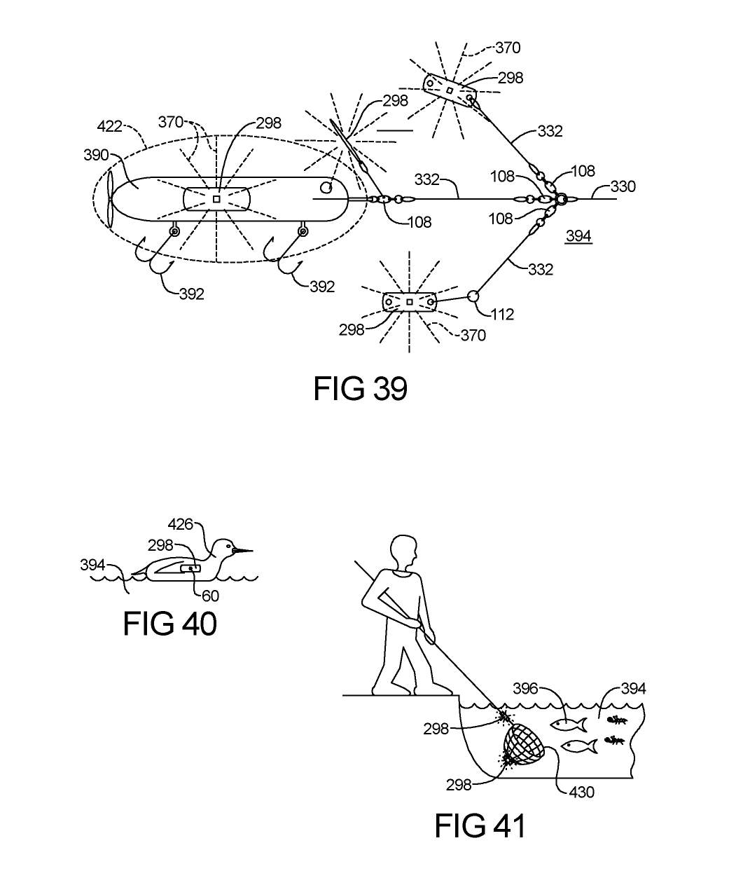

FIG. 39 shows a fish bait 390 in the form of a hard or soft artificial lure with a waterproof lighting assembly 298 adhesively attached to one or both sides of the lure. A volume of illuminated water 422 produced by one or more waterproof lighting assemblies 298 is represented by dashed line 422 surrounding the fish bait 390. An additional waterproof lighting assembly 298 can be clipped to a swivel 109 for enhanced illumination of the lure. Even more illumination can be provided by coupling an additional pair of waterproof lighting assemblies 298 to a three way swivel 108. An optional sinker 112 can be attached to one or both leaders 332 on which the additional pair of waterproof lighting assemblies are attached.

FIG. 40 shows the use of a waterproof lighting assembly 298 on one side of a bird decoy 426. A second waterproof lighting assembly can be provided on the other side of the decoy 426. The waterproof lighting assemblies 298 can be secured to the decoy in any desired location with the adhesive layers 82 (FIG. 2).

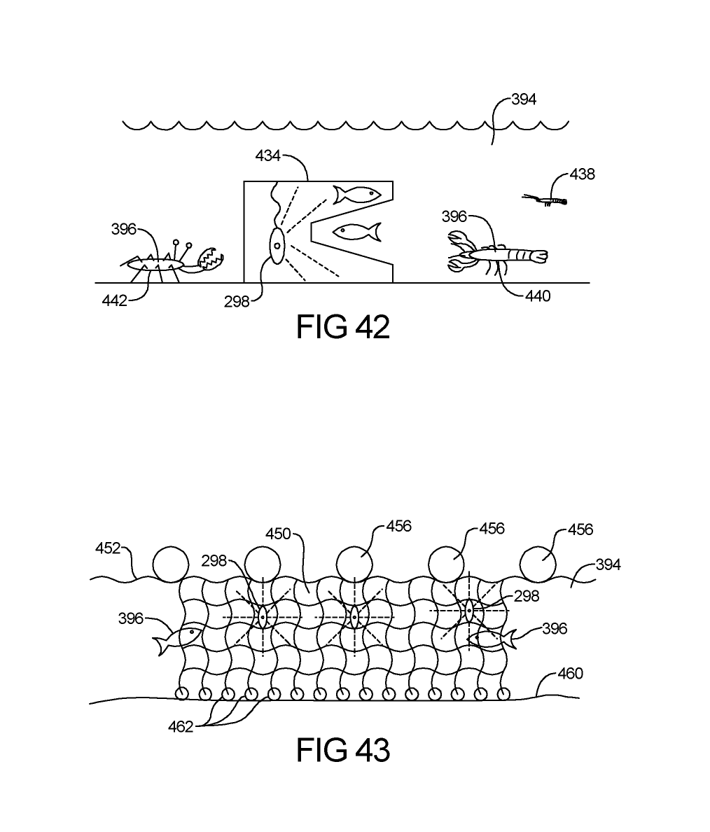

The waterproof lighting assembly 298 can be coupled to a dip net 430 as shown in FIG. 41 to attract fish 396 into the dip net. Another use is shown in FIG. 42 where a waterproof lighting assembly 298 is positioned in or on a static fish trap 434 for attracting and catching any type of fish 396 including shrimp 438, lobster 440 and crabs 442.

Still another use of a waterproof lighting assembly 298 is shown in FIG. 43 where a series of waterproof lighting assemblies are coupled to a gill net 450 held on the surface 452 of the body of water 394 by a series of floats 456 and held on the bottom 460 by a series of weights 462.

As used herein, the term substrate covers all of the articles and applications listed and/or disclosed above as well as other applications requiring safety and/or emergency lighting. As further used herein, the term “about” means plus or minus 10%.

There has been disclosed heretofore the best embodiment of the disclosure presently contemplated. However, it is to be understood that various changes and modifications may be made thereto without departing from the spirit of the disclosure. For example, lighting assemblies 20 can also be coupled to canes, wheelchairs, canoes, and toys.

What is claimed is:

1. A fishing tackle assembly for attracting fish with light, comprising:
a fishing line;
a waterproof lighting assembly disposed adjacent to said fishing line and comprising a battery, a LED, circuitry connecting said battery to said LED, a manually actuated switch selectively operating said LED in a constant on mode, a constant off mode and a strobed mode, and a flexible plastic cover enclosing said battery, said LED, said circuitry and said switch; and
said switch operated by pressing said plastic cover onto said switch.

2. The assembly of claim 1, wherein said flexible plastic cover comprises a flexible plastic pouch having a sealed waterproof border.

3. The assembly of claim 2, wherein said flexible plastic pouch comprises a sealed waterproof chamber and wherein said waterproof lighting assembly further comprises a movable flap extending from said sealed chamber.

4. The assembly of claim 3, further comprising a hinge provided between said waterproof chamber and said movable flap.

5. The assembly of claim 3, wherein said movable flap has an aperture formed therethrough and wherein said fishing line extends through said aperture.

6. The assembly of claim 1, further comprising an adhesive provided on an outer surface portion of said flexible plastic cover and a peel-off cover overlying said adhesive.

7. The assembly of claim 1, wherein said flexible plastic cover comprises a first sheet of flexible plastic bonded to a second sheet of flexible plastic such that said first and second sheets of flexible plastic encapsulate and waterproof said battery, said LED, said circuitry and said switch.

8. The assembly of claim 7, wherein said first sheet of flexible plastic comprises a clear transparent sheet of plastic and wherein said second sheet of flexible plastic comprises an opaque sheet of plastic.

9. The assembly of claim 7 wherein said first and second sheets of plastic comprise clear transparent sheets of plastic.

10. The assembly of claim 7, wherein said LED emits light through said first and second sheets of plastic.

11. The assembly of claim 7 wherein said first sheet of plastic comprises a textured sheet of translucent plastic diffusing light emitted from said LED.

12. The assembly of claim 1, further comprising a sheet of light reflecting material disposed adjacent said LED.

13. The assembly of claim 1 further comprising a layer of spongy shock absorbing material provided over said battery, around said LED and over said switch.

14. The assembly of claim 1, further comprising a fish bait which reflects ultraviolet light and wherein said LED emits ultraviolet light and said fish bait reflects said ultraviolet light emitted from said LED.

15. A compact waterproof light for attracting fish, comprising:
a circuit board;
microcircuitry supported by said circuit board;
a light emitting diode supported by said circuit board,
a battery providing power to said light emitting diode;
a user operated switch selectively operating said light emitting diode in a constant on mode, a constant off mode and a strobed mode;
a flexible plastic waterproof cover comprising a waterproof seal provided around said circuit board, said microcircuitry, said light emitting diode, said battery and said user-operated switch;
a portion of said waterproof seal comprising a flexible hinge; and
a flap pivotally connected to said flexible hinge.

16. The compact waterproof light of claim 15, wherein said waterproof cover and said flap are formed from two strips of plastic and wherein said flap has an aperture formed therein for receiving a fishing line.

17. A method of attracting fish, comprising:
providing a fish bait;
providing a lighting assembly comprising a battery, a light emitting diode, circuitry connecting said battery to said light emitting diode, a user-operated switch connected to said circuitry selectively controlling operation of said light emitting diode in a constant on mode, a constant off mode and a strobed or pulsed mode and a waterproof flexible cover enclosing said battery, said light emitting diode, said circuitry and said user-operated switch;
illuminating said light emitting diode by operating said switch by pressing on said waterproof flexible cover;
placing said fish bait in a body of water containing fish;
placing said lighting assembly in said body of water containing fish;
illuminating a portion of said body of water with said light emitting diode; and
attracting fish to said fish bait by said illuminating a portion of said body of water.

18. The method of claim 17, wherein said light emitting diode emits ultraviolet light and wherein said method further comprises illuminating said fish bait with said ultraviolet light.

19. The method of claim 18, wherein said fish bait comprises a substance that reflects ultraviolet light and wherein said method further comprises illuminating said fish bait with said ultraviolet light and reflecting said ultraviolet light off of said substance that reflects ultraviolet light.

20. The method of claim 18, further comprising providing a material on or adjacent to said light emitting diode that reacts with said ultraviolet light to produce light within the spectrum visible to humans.
